(19) United States
(12) Patent Application Publication
(10) Pub. No.: US 2026/0227601 A1
(43) Pub. Date: Aug. 6, 2026

(54) OPTICAL SYSTEM AND CAMERA MODULE

(71) Applicant: LG INNOTEK CO., LTD., Seoul (KR)

(72) Inventor: Doo Shik SIN, Seoul (KR)

(73) Assignee: LG INNOTEK CO., LTD., Seoul (KR)

(21) Appl. No.: 19/148,220

(22) PCT Filed: Jan. 17, 2024
(86) PCT No.: PCT/KR2024/000871

§ 371 Date: Jul. 15, 2025

(30) Foreign Application Priority Data
Jan. 17, 2023 (KR) 10-2023-0006830

(51) Int. Cl. G02B 13/00; G02B 1/04; G02B 3/00; G02B 15/14; H04N 23/55

(52) U.S. Cl. CPC G02B 13/0045; G02B 1/041; G02B 13/0065; G02B 13/009; G02B 15/143503; H04N 23/55; G02B 2003/0093

(57) ABSTRACT

An optical system disclosed in an embodiment of the invention comprises first to third lens groups, each of which includes at least one lens, arranged along an optical axis from an object toward a sensor side, wherein the first lens group and the third lens group have negative power, the second lens group has positive power, the position of the first lens group is fixed, and each of the second and third lens groups is movable along the optical axis according to an operation mode, and among the lenses of the first lens group, the first lens closest to the object has negative power, the optical axis distance of the first lens group is DG1, the optical axis distance of the second lens group is DG2, and the following Equation: 0.5<DG1/DG2<2 can be satisfied.

### TECHNICAL FIELD

The embodiment relates to an optical system for improved optical performance and a camera module including the same.

### BACKGROUND TECHNOLOGY

The camera module performs the function of photographing an object and saving it as an image or video, and is mounted on various applications. In particular, the camera module is manufactured in an ultra-small size and is applied to portable devices such as smartphones, tablet PCs, and laptops, as well as drones and vehicles, providing various functions. For example, the optical system of the camera module may include an imaging lens that forms an image, and an image sensor that converts the formed image into an electrical signal. At this time, the camera module may perform an autofocus AF function that automatically adjusts the distance between the image sensor and the imaging lens to align the focal length of the lens, and may perform a zooming function of zooming up or zooming out by increasing or decreasing the magnification of a distant object through a zoom lens. In addition, the camera module adopts image stabilization (IS) technology to compensate for or prevent image shake caused by camera movement due to unstable fixation devices or user movement.

The most important element for the camera module to obtain an image is the imaging lens that forms the image. Recently, interest in high resolution has been increasing, and research is being conducted on an optical system including multiple lenses to implement this. For example, research is being conducted using multiple imaging lenses with positive (+) or negative (−) refractive power to implement high resolution. However, there is a problem that it is difficult to derive excellent optical characteristics and aberration characteristics when multiple lenses are included. In addition, when multiple lenses are included, the overall length, height, etc. may increase due to the thickness, distance, size, etc. of the multiple lenses, and this increases the overall size of the module including the multiple lenses.

The size of the image sensor is increasing to implement high-resolution and high-quality images. However, when the size of the image sensor increases, the TTL (Total track length) of the optical system including multiple lenses also increases, which causes a problem in that the thickness of the camera, mobile terminal, etc. including the optical system also increases.

When the optical system includes multiple lenses, the position of at least one lens or a lens group including at least one lens can be controlled to perform zoom, autofocus AF functions, etc. However, when the lens or the lens group performs the function, the amount of movement of the lens or the lens group can increase exponentially. Accordingly, the optical system may require a lot of energy for the movement of the lens or the lens group, and there is a problem in that a large volume is required considering the amount of movement. In addition, there is a problem in that the aberration characteristics due to the movement of the lens or the lens group deteriorate. Accordingly, there is a problem in that the optical characteristics deteriorate at a certain magnification when the zoom or autofocus AF function is performed. Therefore, a new optical system that can solve the above-described problem is required.

### DETAILED DESCRIPTION OF THE INVENTION

### Solution Problem

The embodiment provides an optical system with improved optical characteristics. The embodiment provides an optical system and a camera module capable of photographing at various magnifications. The embodiment provides an optical system and a camera module having improved aberration characteristics at various magnifications. The embodiment provides an optical system and a camera module that can be implemented in a small and compact manner.

### Technical Solution

An optical system according to an embodiment of the invention may include a first to third lens groups, each including at least one lens and arranged along an optical axis from an object side toward a sensor side, wherein the first and third lens groups have negative power, the second lens group has positive power, a position of the first lens group is fixed, each of the second and third lens groups is movable along the optical axis in accordance with an operation mode, a first lens in the first lens group, which is closest to the object, has negative power and a convex surface on a sensor side, a distance along the optical axis of the first lens group is defined as DG1, a distance along the optical axis of the second lens group is defined as DG2, and the following Equation: 0.5<DG1/DG2<2 is satisfied.

According to an embodiment of the invention, the first lens may be made of glass, and other lenses in the first lens group may be made of plastic.

According to an embodiment of the invention, a lens in the second lens group closest to the first lens group may be made of glass, and remaining lenses in the second lens group may be made of plastic.

According to an embodiment of the invention, object-side and sensor-side surfaces of lenses in the first to third lens groups may be aspherical on the optical axis.

According to an embodiment of the invention, a distance along the optical axis of the third lens group may be defined as DG3, a distance along the optical axis from an object-side surface of the lens in the first lens group closest to the object to a top surface of the image sensor may be defined as TTL, and the following Equation: 2<TTL/(DG2+DG3)<5 may be satisfied.

According to an embodiment of the invention, a distance along the optical axis between a lens closest to the image sensor in the third lens group and the image sensor may be variable in accordance with the operation mode, and the operation mode includes a wide mode, a middle mode, and a tele mode.

According to an embodiment of the invention, a distance along the optical axis between an object-side surface of the lens closest to the object in the first lens group and a sensor-side surface of the lens closest to the image sensor in the third lens group may be variable in accordance with the operation mode, and a distance between the first and second lens groups and a distance between the second and third lens groups may be equal to or greater than 0.2 mm and equal to or less than 8 mm.

According to an embodiment of the invention, the wide mode is defined as Md1, a distance between the first and second lens groups in the wide mode may be defined as DG12, a distance between the second and third lens groups may be defined as DG23, and the following Equation: 1<Md1×(DG12/DG23)<5 may be satisfied. The tele mode may be defined as Md3, a distance between the first and second lens groups in the tele mode may be defined as DG12, a distance between the second and third lens groups may be defined as DG23, and the following Equation: 0<Md3×(DG12/DG23)<0.7 may be satisfied.

According to an embodiment of the invention, a maximum distance between adjacent lenses in accordance with the operation mode may be defined as Md_CG_Max, a minimum distance between adjacent lenses in accordance with the operation mode may be defined as Md_CG_Min, and the following Equation: 2<Md_CG_Max/Md_CG_Min<8 may be satisfied.

According to an embodiment of the invention, the number of lenses in the first lens group may be greater than the number of lenses in the second lens group, and an absolute value of the focal length of the first lens group may be greater than that of the second lens group.

According to an embodiment of the invention, an effective focal length in the wide mode may be defined as FMd1, a focal length of the first lens may be defined as F1, and the following Equation: 2<|F1/FMd1|<7 may be satisfied.

According to an embodiment of the invention, an effective focal length in the tele mode is defined as FMd3, and the following Equation: 0<|F1/FMd3|<1 is satisfied, and a field of view in the wide mode may be defined as FOV1, a field of view in the middle mode may be defined as FOV2, a field of view in the tele mode may be defined as FOV3, and the following Equation: 8°<FOV3<FOV2<FOV1<45° may be satisfied.

An optical system according to an embodiment of the invention may include: a first lens group including first to third lenses; a second lens group including fourth and fifth lenses; and a third lens group including sixth to eighth lenses, wherein: the first to third lens groups are arranged in order from an object side toward a sensor side along an optical axis, the first lens has negative refractive power, and has a convex object-side surface, the third lens has negative refractive power, and has a concave sensor-side surface, the fourth lens has positive refractive power and a biconvex shape, the eighth lens has negative refractive power, the second and third lens groups are movable along the optical axis, a distance between the eighth lens and the image sensor is variable in accordance with an operation mode, a refractive index of the first lens is defined as Nd1, and the following Equation: 1.7<Nd1 is satisfied.

According to an embodiment of the invention, the first and third lens groups have negative refractive power, and the second lens has positive refractive power. The fourth lens and the eighth lens each have a refractive index less than 1.6, and the first and fourth lenses are aspherical lenses made of glass. A maximum length of a first direction perpendicular to the optical axis and a maximum length of a second direction of the first lens are different from each other.

According to an embodiment of the invention, a maximum effective size of the largest lens surface among the first to eighth lenses may be defined as CA_Max, and half of a diagonal length of the image sensor is defined as ImgH, and the following Equation: 1<CA_Max/ImgH<3 may be satisfied.

A camera module according to an embodiment of the invention may include: an image sensor; an optical system; and a driving member configured to move at least one of a plurality of lens groups in the optical system along an optical axis, and wherein the optical system includes comprises the optical system disclosed above, and the driving member is configured to move positions of each of the second and third lens groups in the optical axis.

### Effect of the Invention

The optical system and camera module according to the embodiment have various magnifications and can have excellent optical characteristics when providing various magnifications. In detail, the embodiment can have various magnifications by controlling the movement distance of each of the moving lens groups and can provide an autofocus AF function for the subject. The optical system and camera module according to the embodiment can correct aberration characteristics of multiple lens groups or mutually complement aberration characteristics that change due to movement. Accordingly, the optical system according to the embodiment can minimize or prevent changes in chromatic aberration and aberration characteristics that occur when the magnification changes.

The optical system and camera module according to the embodiment can control the effective focal length EFL by moving only some of the multiple lens groups and can minimize the movement distance of the moving lens group. Accordingly, the optical system can reduce the movement distance of the moving lens group according to the change in the operation mode and can minimize the power consumption required when the lens group moves. The optical system can have at least one lens included in the fixed group and the moving group have a non-circular shape. Accordingly, the optical system can reduce the height of the optical system while maintaining the optical performance, and secure a space where the lens groups arranged between the plurality of lens groups are structurally arranged.

The optical system and camera module according to the embodiment can adjust the magnification by moving a lens group other than the first lens group adjacent to the subject among the plurality of lens groups. Accordingly, the optical system can have a constant TTL value even when the lens group moves according to the change in magnification. Therefore, the optical system and the camera module including the same can be provided with a slimmer structure.

### BRIEF DESCRIPTION OF THE DRAWINGS

FIG. 1 is a configuration diagram of an optical system and a camera module having the same according to an embodiment of the invention.

FIG. 2 is an example of a change in the first mode of the optical system of FIG. 1.

FIG. 3 is an example of a change in the third mode in the optical system of FIGS. 1 and 2.

FIG. 4 is a configuration having a reflective mirror in the optical system of FIG. 1.

FIG. 5 is a table of lens data of an optical system according to an embodiment of the invention.

FIG. 6 is a table illustrating aspherical coefficients of lenses of an optical system according to an embodiment of the invention.

FIG. 7 is a graph illustrating relative illumination according to positions of wide, middle, and tele modes according to an embodiment of the invention.

FIG. 8 is a graph illustrating diffraction MTF in an optical system of a first mode (Wide Mode) according to an embodiment of the invention.

FIG. 9 is a graph illustrating diffraction MTF in an optical system of a second mode (Middle Mode) according to an embodiment of the invention.

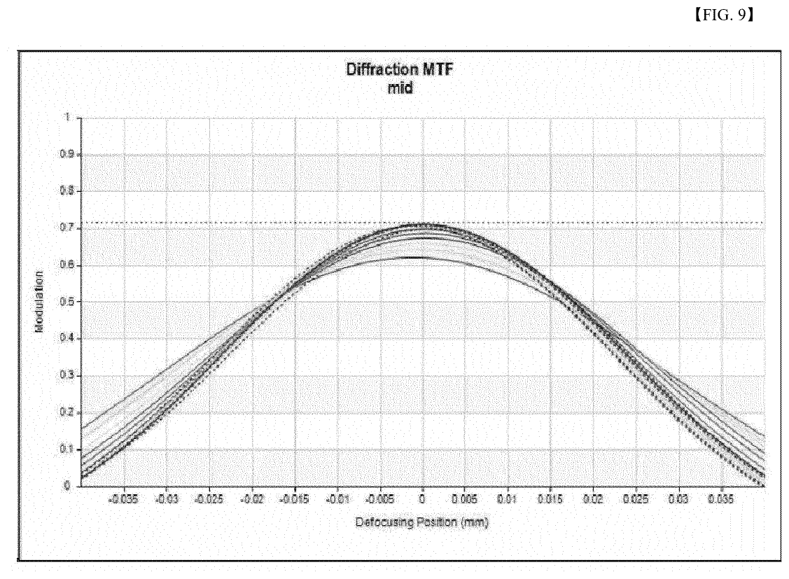

FIG. 10 is a graph illustrating diffraction MTF in an optical system of a third mode (Tele Mode) according to an embodiment of the invention.

FIG. 11 is a graph illustrating aberration characteristics in an optical system of a first mode according to an embodiment of the invention.

FIG. 12 is a graph illustrating aberration characteristics in an optical system of a second mode according to an embodiment of the invention.

FIG. 13 is a graph illustrating aberration characteristics in an optical system of a third mode according to an embodiment of the invention.

FIG. 14 is a drawing illustrating a camera module according to an embodiment of the invention applied to a mobile terminal.

### BEST MODE

Hereinafter, preferred embodiments of the present invention will be described in detail with reference to the attached drawings. However, the technical idea of the present invention is not limited to some of the embodiments described, but can be implemented in various different forms, and within the scope of the technical idea of the present invention, one or more of the components among the embodiments can be selectively combined or substituted and used. In addition, terms (including technical and scientific terms) used in the embodiments of the present invention can be interpreted as meanings that can be generally understood by a person having ordinary knowledge in the technical field to which the present invention belongs, unless explicitly and specifically defined and described, and terms commonly used, such as terms defined in a dictionary, can be interpreted in consideration of the contextual meaning of the related technology. The terms used in the embodiments of the present invention are for describing the embodiments and are not intended to limit the present invention.

In this specification, the singular may also include the plural unless specifically stated in the phrase, and when it is described as “A and (or) at least one (or more) of B, C,” it may include one or more of all combinations that can be combined with A, B, C. In addition, when describing components of embodiments of the present invention, terms such as first, second, A, B, (a), (b), etc. may be used. These terms are only intended to distinguish the components from other components, and are not limited by the nature, order, or sequence of the components. In addition, when it is described that a component is “connected,” “coupled,” or “connected” to another component, it may include not only cases where the component is directly connected, coupled, or connected to the other component, but also cases where the component is “connected,” “coupled,” or “connected” by another component between the component and the other component. In the specification, when it is described as being formed or arranged “above or below” each component, “above” or “below” includes not only cases where two components are in direct contact with each other, but also cases where one or more other components are formed or arranged between the two components. In addition, when it is expressed as “above or below”, it may include the meaning of not only the upward direction but also the downward direction with respect to one component.

In the specification, the convex surface of the lens may mean that the lens surface of the area corresponding to the optical axis has a convex shape based on the optical axis, and the concave surface of the lens may mean that the lens surface of the area corresponding to the optical axis has a concave shape. In addition, the “object-side surface” may mean the surface of the lens facing the object side based on the optical axis, and the “sensor-side surface” may mean the surface of the lens facing the imaging surface (image sensor) based on the optical axis. In addition, the center thickness of the lens may mean the thickness of the lens in the optical axis direction. In addition, the vertical direction may mean the direction perpendicular to the optical axis, and the end of the lens or lens surface may mean the end of the effective area of the lens through which the incident light passes. In addition, the size of the effective diameter of the lens surface may have a measurement error of up to ±0.4 mm depending on the measurement method, etc.

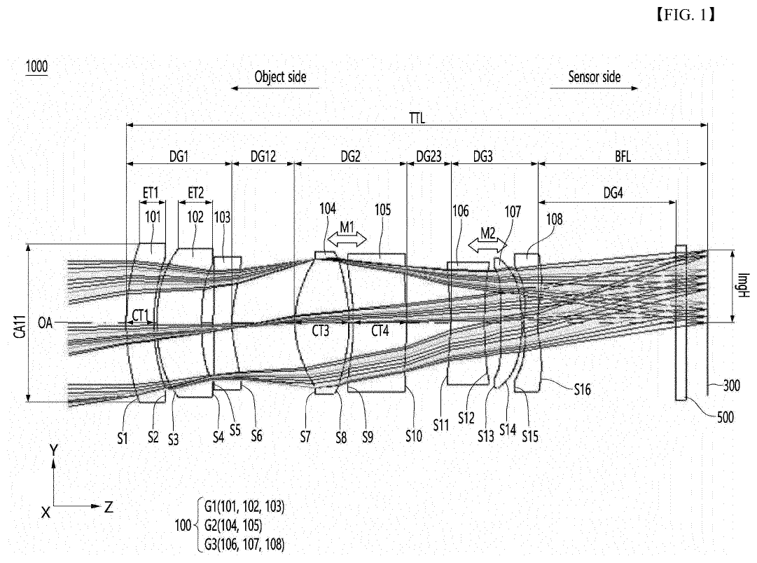

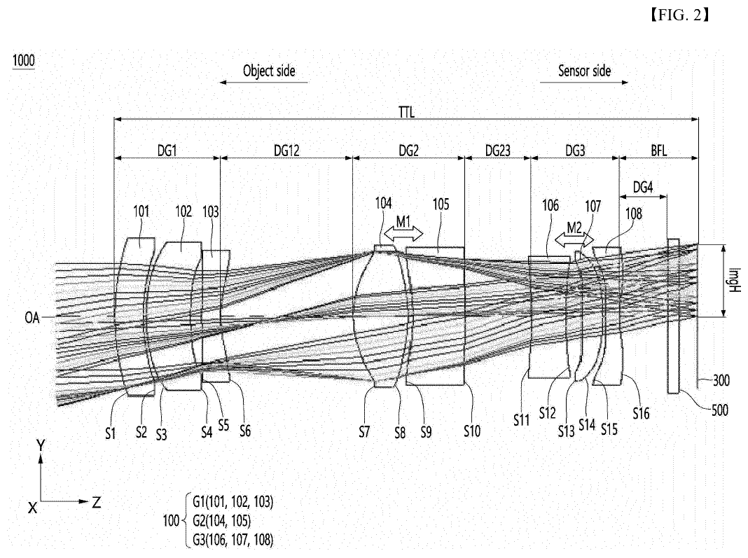

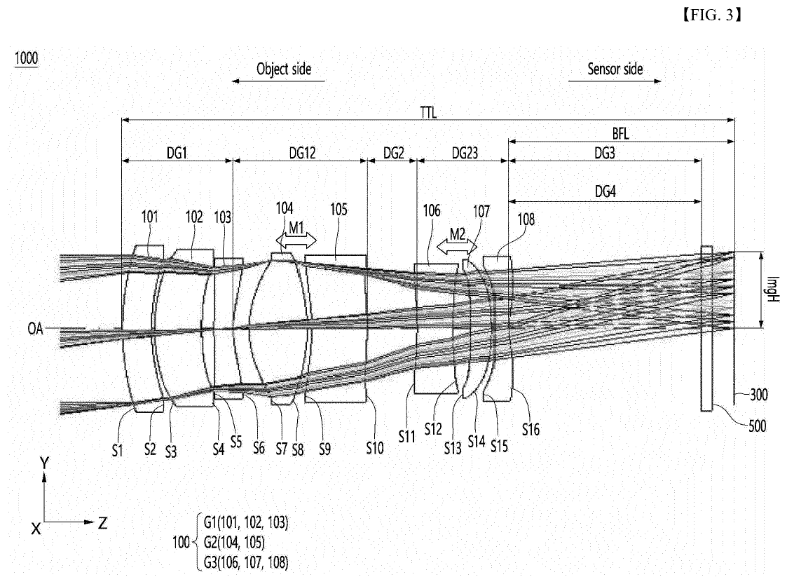

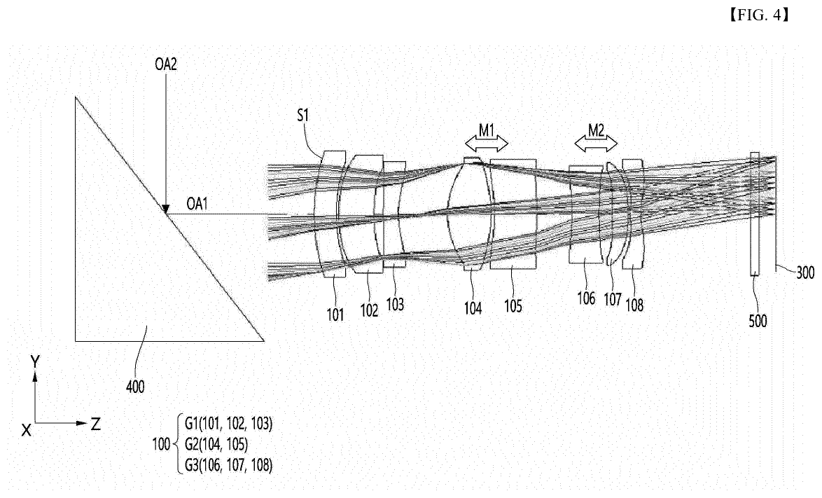

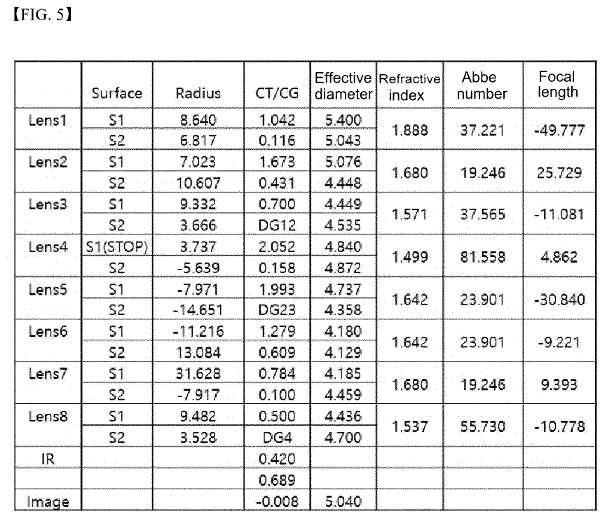

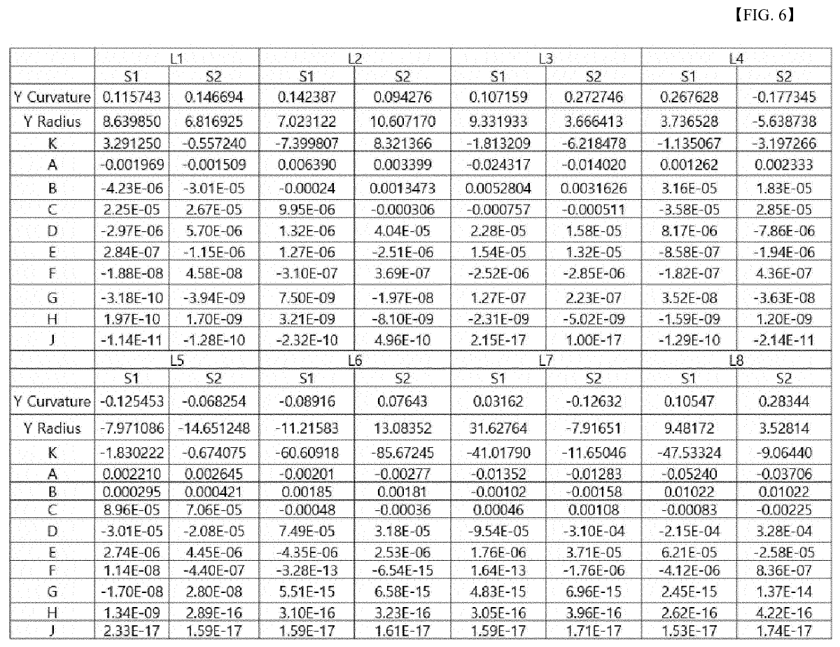

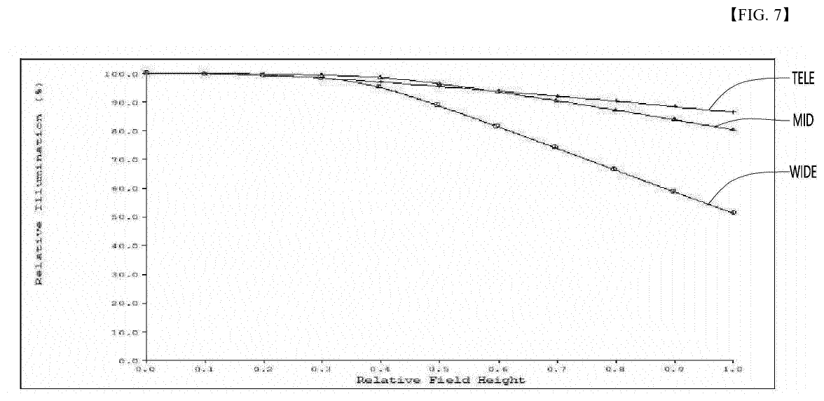

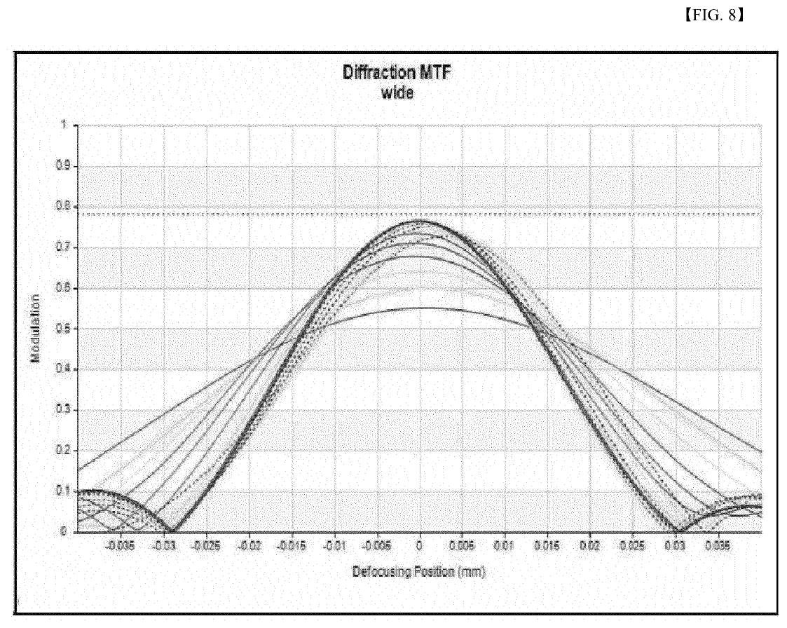

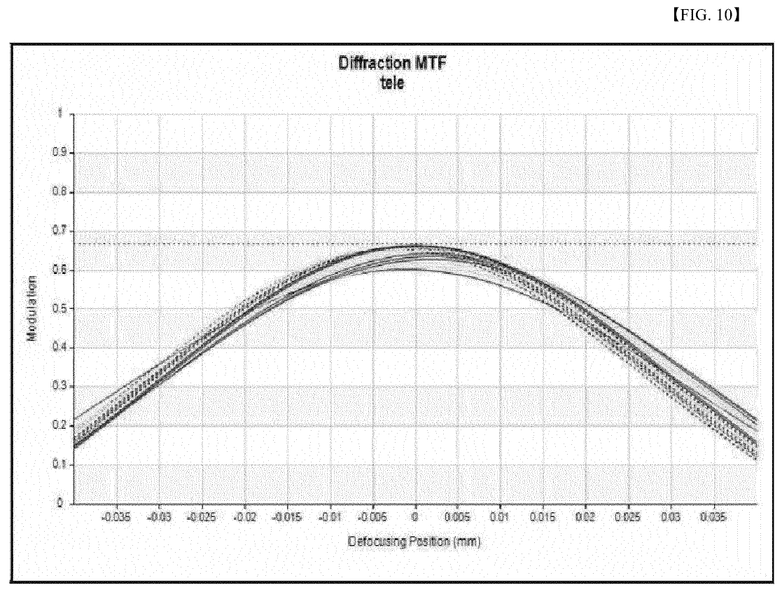

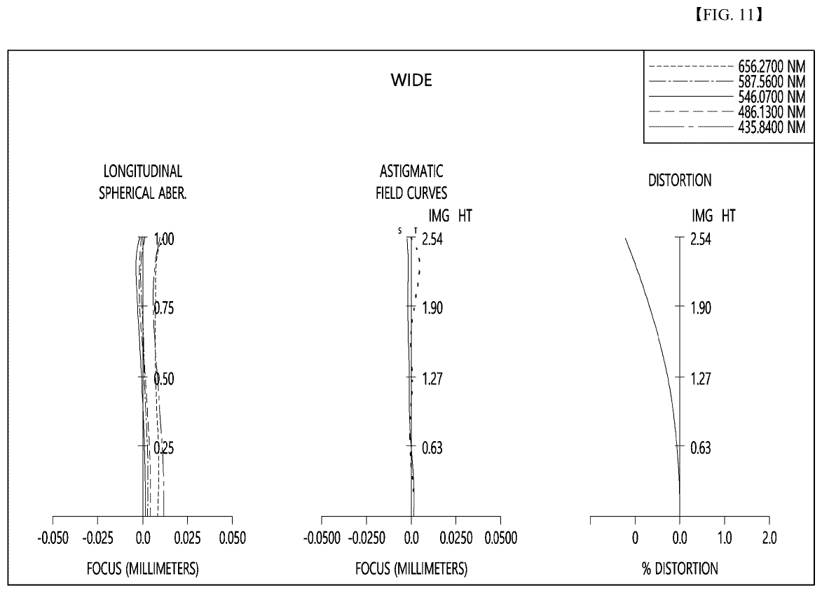

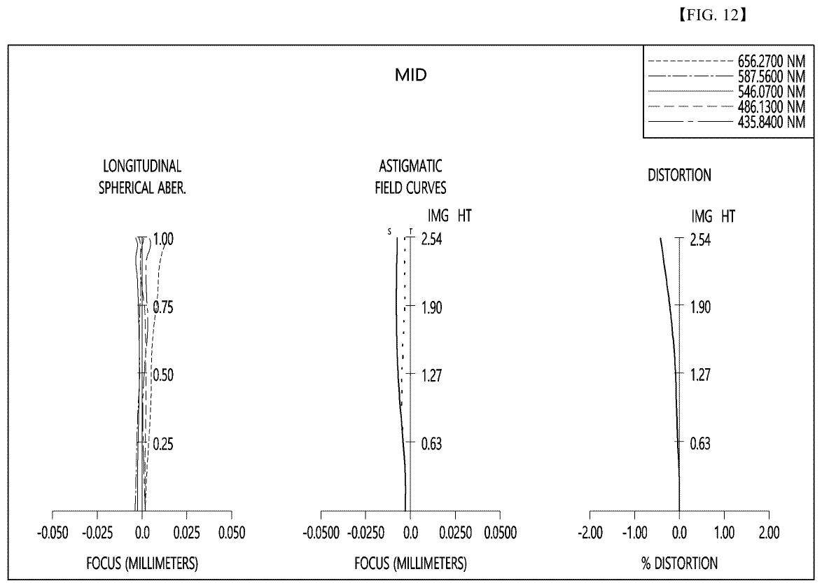

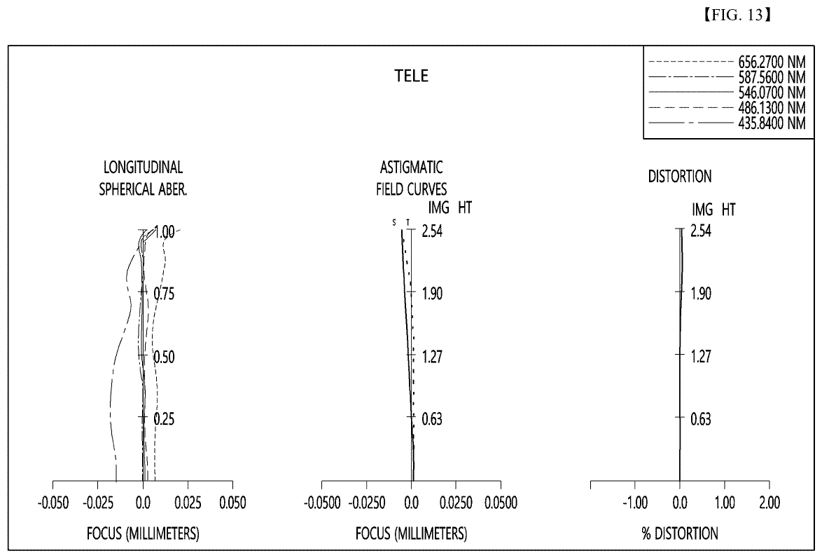

FIG. 1 is a configuration diagram of a first mode of a camera module or optical system according to an embodiment of the invention, FIG. 2 is an example of a change from the first mode of the optical system of FIG. 1 to the second mode, FIG. 3 is an example of a change from the optical system of FIGS. 1 and 2 to the third mode, FIG. 4 is a configuration having a reflective mirror in the optical system of FIG. 1, FIG. 5 is a table of lens data of an optical system according to an embodiment of the invention, FIG. 6 is a table illustrating aspherical coefficients of lenses of an optical system according to an embodiment of the invention, FIG. 7 is a graph illustrating relative illumination according to positions of Wide, Middle, and Tele modes in a camera module according to an embodiment of the invention, FIG. 8 is a graph of diffraction MTF in an optical system of a first mode (Wide Mode) according to an embodiment of the invention, and FIG. 8 is a graph of diffraction MTF in an optical system of a second mode (Middle mode) according to an embodiment of the invention, and FIG. 10 is a graph of diffraction MTF in an optical system of a third mode (Tele mode) according to an embodiment of the invention, FIG. 11 is a graph illustrating aberration characteristics in an optical system of a first mode according to an embodiment of the invention, FIG. 12 is a graph illustrating aberration characteristics in an optical system of a second mode according to an embodiment of the invention, and FIG. 13 is a graph illustrating aberration characteristics in an optical system of a third mode according to an embodiment of the invention.

Referring to FIGS. 1 to 6, an optical system 1000 according to an embodiment may include a plurality of lens groups G1, G2, and G3. In detail, the plurality of lens groups G1, G2, and G3 may have at least two lens groups that are movable in the direction of the optical axis OA and at least one lens group that is fixed in position. The plurality of lens groups G1, G2, and G3 may include a lens group fixed on the object side and a plurality of movable lens groups that are movable on the sensor side.

The plurality of moving lens groups may include an object-side lens group and a sensor-side lens group. The lens group fixed on the object side may be defined as a first lens group G1, an object-side moving lens group may be defined as a second lens group G2, and a sensor-side moving lens group may be defined as a third lens group G3. The second lens group G2 may be arranged between the first lens group G1 and the third lens group G3.

The first lens group G1 refracts incident light toward the second lens group G2, the second lens group G2 moves along the optical axis OA and changes the zoom magnification (focal length), and the third lens group G3 moves along the optical axis OA and adjusts the focus position on the image surface of the image sensor 300.

The optical system 1000 may include a first lens group G1, a second lens group G2, and a third lens group G3 sequentially arranged along the optical axis OA from the object side toward the sensor side. The optical system 1000 may include an image sensor 300 on the sensor side of the third lens group G3. The first lens group G1 may include a lens closest to the object side, and the third lens group G3 may include a lens closest to the sensor side. Each of the first to third lens groups G1, G2, and G3 may have positive (+) or negative (−) refractive power. For example, a lens group having positive refractive power may be smaller than a lens group having negative refractive power.

The first lens group G1 may have refractive power opposite to the refractive power of the second lens group G2. For example, the first lens group G1 may have negative (−) refractive power, and the second lens group G2 may have positive (+) refractive power. The second lens group G2 may have a refractive power of a sign opposite to the sign of the refractive power of the third lens group G3. For example, the second lens group G2 may have positive (+) refractive power, and the third lens group G3 may have negative (−) refractive power.

The absolute value of the focal length of the first lens group G1 may be greater than the absolute value of the focal lengths of the second and third lens groups G2, G3. For example, the absolute value of the focal length of the first lens group G1 may be more than twice the focal length of the second lens group G2. Accordingly, the first lens group G1 may disperse the incident light. The focal length of the second lens group G2 may be smaller than the absolute value of the focal length of the third lens group G3. The absolute value of the focal length of the third lens group G3 may be smaller than the absolute value of the focal length of the first lens group G1. The power of the first and third lens groups G1 and G3 may have negative power, and the power of the second lens G2 may have positive power. The power is the reciprocal of the focal length value.

The number of lenses of the first lens group G1 may be larger than the number of lenses of the second lens group G2. The number of lenses of the second lens group G2 may be equal to or smaller than the number of lenses of the third lens group G3. The number of lenses of the first lens group G1 may include at least three lenses for adjusting the amount of incident light, refractive power, and chromatic aberration. The third lens group G3 may include at least two or three lenses.

The number of lenses in the first to third lens groups G1, G2, and G3 may be two or more. At least one of the first and third lens groups G1 and G3 may include three or more lenses. As another example, the optical system may further include at least one lens whose position is fixed between the third lens group G3 and the image sensor 300. Accordingly, the optical system 1000 may include seven or more and ten or fewer lenses.

Since the first and second lens groups G1 and G2 have refractive powers of opposite signs (+, −), aberrations can be corrected, and since the second and third lens groups G2 and G3 have refractive powers of opposite signs (+, −), aberrations can be corrected. The absolute value of the focal length of each of the first to third lens groups G1, G2, and G3 can decrease in the order of the first lens group G1, the third lens group G3, and the second lens group G2. Since the first lens group G1 is fixed in position, and the second lens group G2 and the third lens group G3 can move in the direction of the optical axis OA, the optical system 1000 can provide various magnifications by the movement of the lens groups. Hereinafter, the first to third lens groups G1, G2, and G3 will be described in more detail. The first lens group G1 may have at least two lenses having refractive powers of opposite signs, and at least two lenses having refractive powers of the same sign. For example, the first lens group G1 may include three lenses. The first lens group G1 may have a greater number of lenses having negative refractive powers than lenses having positive refractive powers.

The first lens group G1 includes a plurality of lenses, and the plurality of lenses may have a set interval on the optical axis OA. In detail, the center interval between the plurality of lenses 101, 102, and 103 included in the first lens group G1 may be a fixed interval according to the operation mode described below. For example, the center interval between adjacent lenses 101, 102, and 103 may not change depending on the operation mode and may have a constant interval. Here, the center interval between the lenses may mean the optical axis interval between adjacent lenses.

The second lens group G2 may include a plurality of lenses, and may include lenses 104 and 105 having opposite refractive powers. The plurality of lenses 104 and 105 included in the second lens group G2 may have a set interval. In detail, the center interval between adjacent lenses 104 and 105 may be a fixed interval according to the operation mode described later.

The third lens group G3 may include a plurality of lenses, and may include two or more lenses having opposite refractive powers. The number of lenses included in the third lens group G3 may be greater than the number of lenses having positive refractive powers. The number of lenses included in the third lens group G3 may be one or more more than the number of lenses included in the second lens group G2. The number of lenses included in the third lens group G3 may be the same as the number of lenses included in the first lens group G1. For example, the third lens group G3 may include three lenses.

The plurality of lenses 106, 107, and 108 included in the third lens group G3 may have a set interval. In detail, the center interval between the plurality of lenses 106, 107, and 108 included in the third lens group G3 may not change and may be constant even if the operation mode described below changes. For example, the center intervals between adjacent lenses 106, 107, and 108 may not change and may be constant depending on the operation mode. The last lens included in the third lens group G3 has a set interval with the image sensor 220 or/and the optical filter 500, and the interval may vary depending on the operation mode.

The optical system 1000 may include first to eighth lenses 101-108. The first lens group G1 may include the first to third lenses 101, 102, 103, and the second lens group G2 may include the fourth and fifth lenses 104, 105. In addition, the third lens group G3 may include the sixth to eighth lenses 106, 107, 108. The first to eighth lenses 101-108 and the image sensor 300 may be sequentially arranged along the optical axis OA of the optical system 1000.

The first lens group G1 may have an effective length in the first direction (X) perpendicular to the optical axis and an effective length in the second direction (Y) that are different from each other. The lenses of the first lens group G1 having different effective lengths in the first and second directions (X, Y) may be non-circular lenses, and for example, the effective length in the second direction (Y) may be shorter than the effective length in the first direction (X). One or more of the first to third lenses 101, 102, and 103 may have an effective length in the second direction (Y) of the object-side surface thereof shorter than the effective length in the first direction (X). The second lens group G2 may have at least one of the internal lenses such that the effective length in the first direction (X) and the effective length in the second direction (Y) are different from each other when perpendicular to the optical axis. The lenses of the second lens group G2 having different effective lengths in the first and second directions (X, Y) may be non-circular lenses, and for example, the effective length in the second direction (Y) may be shorter than the effective length in the first direction (X). One or both of the fourth and fifth lenses 104 and 105 may have an effective length in the second direction (Y) of the object-side surface that is shorter than the effective length in the first direction (X).

The third lens group G3 may have at least one of the internal lenses having different lengths in the first direction (X) and the second direction (Y) that are orthogonal to the optical axis. The lenses of the first lens group G1 having different effective lengths in the first and second directions (X, Y) may be non-circular lenses, and for example, the effective length in the second direction (Y) may be shorter than the effective length in the first direction (X). Specifically, the first lens 101 having the largest effective length among the lenses in the lens unit 100 may have an effective length in the first direction (X) that is longer than the effective length in the second direction (Y). The second lens 102 may have an effective length in the first direction (X) that is longer than the effective length in the second direction (Y). The fourth lens 104 may have an effective length in the first direction (X) that is longer than the effective length in the second direction (Y).

The optical system 1000 according to the embodiment may have improved assembly properties by non-circular lens(es) and may have a mechanically stable shape. In addition, the optical system 1000 may significantly reduce the moving distance of the moving lens group and provide various magnifications. In addition, since the lenses having a large effective length in the second direction (Y) are provided in a shape in which both sides in the second direction (Y) are cut, the height or thickness of the optical system 1000 and the camera module in the second direction (Y) may be reduced. Accordingly, the increase in the thickness of the device having the slim optical system 1000 and the camera module may be suppressed.

Each lens in the lens unit 100 may include an effective area and an ineffective area. The above effective area is an effective area, and may be an area through which light incident on each of the first to eighth lenses 101-108 passes. The effective area may be an area in which the incident light is refracted to implement optical characteristics. The non-effective area may be arranged around the effective area. The non-effective area may be an area in which the light is not incident. In other words, the non-effective area may be an area unrelated to the optical characteristics. In addition, the non-effective area may be an area fixed to a barrel (not shown) that accommodates the lens.

The image sensor 300 may detect light. The image sensor 300 may detect light that has sequentially passed through the lens unit 100, for example, the first to eighth lenses 101-108. The image sensor 300 may include a CCD (Charge Coupled Device) or a CMOS (Complementary Metal Oxide Semiconductor).

The optical system 1000 may further include an optical filter 500. The optical filter 500 may be arranged between the lens unit 100 and the image sensor 300. The optical filter 500 may be arranged between the image sensor 300 and the third lens group G3. For example, the optical filter 500 may be arranged between the eighth lens 108 and the image sensor 300. The optical filter 500 may include at least one of an infrared filter and a cover glass. The optical filter 500 may pass light of a set wavelength band and filter light of a different wavelength band. When the optical filter 500 includes an infrared filter, it may block radiant heat emitted from external light from being transmitted to the image sensor 300. The optical filter 500 may transmit visible light and reflect infrared light.

The optical system 1000 may include an aperture (not shown). The aperture may control the amount of light incident on the optical system 1000. The aperture may be arranged around the object-side surface of the fourth lens 104. The aperture may be arranged between two lenses selected from the first to eighth lenses 101-108. For example, the aperture may be arranged around the third lens 103 and the fourth lens 104. The aperture may be arranged around the sensor-side surface of the third lens 103 or the object-side surface of the fourth lens 104. Alternatively, at least one lens among the first to eighth lenses 101-108 may function as an aperture. For example, the outer surface of the object-side surface or the sensor-side surface of one lens selected from the first to eighth lenses 101-108 may function as an aperture for controlling the amount of light. For example, at least one lens surface among the sensor-side surface of the third lens 103 and the object-side surface of the fourth lens 104 may function as an aperture.

The object-side surface and the sensor-side surface of the first to eighth lenses 101-108 may be aspherical. At least one of the first to eighth lenses 101-108 may be made of glass. For example, at least one of the lenses of the first lens group G1 may be made of glass. At least one of the lenses of the second lens group G2 may be made of glass. The lenses of the third lens group G3 may be made of plastic. As another example, at least one of the lenses of the third lens group G3 may be made of glass. The lens of the glass material may be a glass mold lens manufactured by injection molding. The above first and fourth lenses 101, 104 may be glass mold lenses, and the above second, third, fifth, sixth, seventh, and eighth lenses 102, 103, 105, 106, 107, and 108 may be made of plastic. Since a glass lens is placed in the lens unit 100, heat compensation can be satisfied and optical characteristics can be prevented from being degraded due to temperature changes.

As shown in FIG. 4, the optical system 1000 may further include an optical path changing member 400. The optical path changing member 400 may reflect light incident from the outside and change the path of the light from the second path OA2 to the first path OA1. The optical path changing member 400 may include a reflector or a prism. For example, the optical path changing member 400 may include a right-angled prism. When the optical path changing member 400 includes a right-angle prism, the optical path changing member 400 can reflect the second path OA2 of incident light at an angle of 90 degrees to change the first path OA1 of light. The first path OA1 may be in the direction of the optical axis of the optical system. The optical path changing member 400 may be arranged closer to the object side than the plurality of lenses. That is, when the optical system 1000 includes the optical path changing member 400, the optical path changing member 300, the first lens 101, the second lens 102, the third lens 103, the fourth lens 104, the fifth lens 105, the sixth lens 106, the seventh lens 107, the eighth lens 108, the filter 500, and the image sensor 300 may be arranged in this order from the object side toward the sensor.

The optical path changing member 400 can change the path of light incident from the outside to a set direction. For example, the optical path changing member 400 can change the second path OA2 of light incident on the optical path changing member 400 in a second direction (Y) to a first path OA1 in a third direction (Z) which is the arrangement direction of the plurality of lenses. When the optical system 1000 includes the optical path changing member 400, the optical system can be applied to a folded camera, thereby reducing the thickness of the camera. In detail, when the optical system 1000 includes the optical path changing member 400, light incident in a direction (Y) perpendicular to a surface of a device to which the optical system 1000 is applied can be changed to a direction (Z) parallel to the surface of the device. Accordingly, the optical system 1000 including a plurality of lenses can have a thinner thickness within the device, so that the height of the device can be reduced.

If the optical system 1000 does not include the optical path changing member, the plurality of lenses can be arranged to extend in a direction (Y) perpendicular to the surface of the device within the device. Accordingly, the optical system 1000 including the plurality of lenses has a high height in a direction (first direction) perpendicular to the surface of the device, so that it can be difficult to form the thickness of the optical system 1000 and the device including it thin. However, if the optical system 1000 includes the optical path changing member 400, the plurality of lenses can be arranged to extend in a direction (Z) parallel to the surface of the device. That is, the optical system 1000 is arranged so that the optical axis OA is parallel to the surface of the device, and can be applied to a folded camera. Accordingly, the optical system 1000 including the lens unit 100 may have a low height in a direction perpendicular to the surface of the device. Therefore, the camera including the optical system 1000 may have a thin thickness within the device, and the thickness of the device may also be reduced. As another example, the optical path changing member may be arranged between two lenses of the lens unit 100, or may be further arranged between the last lens adjacent to the image sensor 300 and the image sensor 300. As another example, the optical path changing member may be provided in multiple pieces. In detail, a plurality of the optical path changing members may be arranged between the object and the image sensor 300. For example, the plurality of optical path changing members may include a first optical path changing member arranged closer to the object side than the plurality of lenses, and a second optical path changing member arranged between the last lens and the image sensor 300. Accordingly, the optical system 1000 may have various shapes and heights depending on the camera to which it is applied, and may have improved optical performance.

Referring to FIGS. 1 to 3, the first lens 101 may be arranged closest to the object among the plurality of lenses, and the eighth lens 108 may be arranged closest to the image sensor 300. For convenience of explanation, the center thickness of each of the first to eighth lenses 101-108 is CT1-CT8, the edge thickness is ET1-ET8, the Abbe number is Vd1-Vd8, the refractive index is Nd1-Nd8, the average of the effective lengths is CA1-CA8, and the focal length may be defined as F1-F8. The first lens 101 may have negative (−) refractive power on the optical axis OA. The first lens 101 may include a plastic or glass material, and may be, for example, a glass material. The first lens 101 may include a first surface S1 on the object side and a second surface S2 on the sensor side. The first surface S1 may have a convex shape on the optical axis OA, and the second surface S2 may have a concave shape on the optical axis OA. That is, the first lens 101 may have a meniscus shape that is convex toward the object on the optical axis OA. Alternatively, the first lens 101 may have a first surface S1 that is concave on the optical axis, and a second surface S2 that is convex on the optical axis OA. At least one surface of the first surface S1 and the second surface S2 may be aspherical. For example, both the first surface S1 and the second surface S2 may be aspherical. The aspherical coefficients of the first and second surfaces S1, S2 may be represented by L1S1 and L1S2 in FIG. 6.

The maximum effective length of the first lens 101 may be the largest among the lenses. That is, the effective length of the first surface S1 of the first lens 101 in the second direction (Y) may be the largest among the lenses. The average of the effective lengths of the first and second surfaces S1, S2 of the first lens 101 in the second direction (Y) may be larger than the average of the effective lengths of the object-side surfaces and the sensor-side surfaces of the second to eighth lenses 102-108. Accordingly, the first lens 101 may improve optical aberrations or control incident light. The first surface S1 and the second surface S2 may be provided without a critical point from the optical axis to the end of the effective area.

The second lens 102 may have positive (+) or negative (−) refractive power on the optical axis OA, and may have positive refractive power, for example. The second lens 102 may include a plastic or glass material, and may be made of a plastic material, for example. The second lens 102 may include a third surface S3 defined as an object-side surface and a fourth surface S4 defined as a sensor-side surface. The third surface S3 may have a convex shape on the optical axis OA, and the fourth surface S4 may have a concave shape on the optical axis OA. The second lens 102 may have a convex meniscus shape toward the object in the optical axis OA. Alternatively, the third surface S3 may have a convex shape on the optical axis OA, and the fourth surface S4 may have a convex shape. Alternatively, the third surface S3 may have a concave shape on the optical axis OA, and the fourth surface S4 may have a convex shape on the optical axis OA. Alternatively, the third surface S3 may have a concave shape on the optical axis OA, and the fourth surface S4 may have a concave shape on the optical axis OA. At least one of the third surface S3 and the fourth surface S4 of the second lens 102 may be aspherical. For example, both the third surface S3 and the fourth surface S4 may be aspherical. The aspherical coefficients of the third and fourth surfaces S3, S4 can be represented by L2S1 and L2S2 in FIG. 6. The third surface S3 and the fourth surface S4 can be provided without a critical point from the optical axis to the end of the effective area.

The third lens 103 may have a refractive power of the same sign as the refractive power of the first lens 101 on the optical axis OA. That is, the third lens 103 may have a negative (−) refractive power. The third lens 103 may include a plastic or glass material, and may be, for example, a plastic material. The third lens 103 may include a fifth surface S5 defined as an object-side surface and a sixth surface S6 defined as a sensor-side surface. The fifth surface S5 may have a convex shape on the optical axis OA, and the sixth surface S6 may have a concave shape on the optical axis OA. In contrast, the fifth surface S5 may have a convex shape on the optical axis OA, and the sixth surface S6 may have a convex shape. In contrast, the fifth surface S5 may have a concave shape on the optical axis OA, and the sixth surface S6 may have a concave shape. At least one of the fifth surface S5 and the sixth surface S6 of the third lens 103 may be aspherical. For example, both the fifth surface S5 and the sixth surface S6 may be aspherical. The aspherical coefficients of the fifth and sixth surfaces S5, S6 may be represented by L3S1 and L3S2 of FIG. 6. The fifth surface S5 and the sixth surface S6 may be provided without critical points from the optical axis to the end of the effective area.

The second lens 102 and the third lens 103 may compensate for chromatic aberration occurring in the first lens 101. The refractive index of the first lens 101 made of the glass material may be the largest among all the lenses. For example, the refractive index of the first lens 101 may be 1.7 or higher, for example, 1.8 or higher. The radius of curvature of the sixth surface S6 of the third lens 103 may be the smallest among the radii of curvature of the object-side surface and the sensor-side surface of each lens 101, 102, and 103 of the first lens group G1. Accordingly, since the first lens group G1 controls the dispersion of light provided to the second lens group G2, the lens size of the second lens group G2 may be reduced. The variable size of the center distance DG12 between the first and second lens groups G1 and G2 may be set according to the operating mode by the radius of curvature of the sixth surface S6 of the third lens 103.

The fourth lens 104 may have a positive (+) refractive power on the optical axis OA. The fourth lens 104 may include a plastic or glass material, for example, may be a glass material, and may have a refractive index of less than 1.6. The fourth lens 104 may include a seventh surface S7 defined as an object-side surface and an eighth surface S8 defined as a sensor-side surface. The seventh surface S7 may have a convex shape on the optical axis OA, and the eighth surface S8 may have a convex shape on the optical axis OA. That is, the fourth lens 104 may have a convex shape on both sides in the optical axis OA. In contrast, the seventh surface S7 may be convex in the optical axis OA, and the eighth surface S8 may be concave in the optical axis OA. That is, the fourth lens 104 may have a convex meniscus shape toward the object from the optical axis OA. At least one of the seventh surface S7 and the eighth surface S8 of the fourth lens 104 may be aspherical. For example, both the seventh surface S7 and the eighth surface S8 may be aspherical. The aspherical coefficients of the seventh and eighth surfaces S7, S8 may be expressed as L4S1 and L4S2 of FIG. 6. The seventh surface S7 and the eighth surface S8 may be provided without a critical point from the optical axis to the end of the effective area.

The fifth lens 105 may have positive (+) or negative (−) refractive power from the optical axis OA. The fifth lens 105 may have a negative refractive power opposite to that of the fourth lens 104 in the optical axis OA. The fifth lens 105 may include a plastic or glass material, and may be, for example, a plastic material. The fifth lens 105 may include a ninth surface S9 defined as an object-side surface and a tenth surface S10 defined as a sensor-side surface. The ninth surface S9 may have a concave shape on the optical axis OA, and the tenth surface S10 may have a convex shape on the optical axis OA. That is, the fifth lens 105 may have a convex meniscus shape toward the sensor in the optical axis OA. At least one surface of the ninth surface S9 and the tenth surface S10 may be aspherical. For example, both the ninth surface S9 and the tenth surface S10 may be aspherical. The aspherical coefficients of the ninth and tenth surfaces S9, S10 may be represented by L5S1 and L5S2 of FIG. 6. The ninth surface S9 and the tenth surface S10 of the fifth lens 105 may be provided without a critical point from the optical axis to the end of the effective area. As another example, the ninth surface S9 of the fifth lens 105 may have a convex shape on the optical axis OA, and the tenth surface S10 may have a convex shape on the optical axis OA. That is, the fifth lens 105 may have a convex shape on both sides on the optical axis OA. In this way, the ninth surface S9 may have a concave shape on the optical axis OA, and the tenth surface S10 may have a concave shape on the optical axis OA. In this way, the ninth surface S9 may have a convex shape on the optical axis OA, and the tenth surface S10 may have a concave shape on the optical axis OA.

The fourth lens 104 has a convex shape on both sides, and the center thickness CT4 of the fourth lens 104 may be thicker than the edge thickness ET4, for example, may be twice or more the edge thickness. Accordingly, the distance between the fourth lens 104 and the fifth lens 105 may be reduced. The Abbe number Vd4 of the fourth lens 104 may be the largest among the Abbe numbers of the first to eighth lenses 101-108. The difference in the Abbe number between the fourth lens 104 and the fifth lens 105 may be greater than 20 or greater than 30, and may be at most 65 or less. Accordingly, the second lens group G2 may minimize the change in chromatic aberration caused by the position changing according to the change in the operation mode.

The sixth lens 106 may have positive (+) or negative (−) refractive power on the optical axis OA, and may have negative refractive power, for example. The sixth lens 106 may include a plastic or glass material, and may be made of a plastic material, for example. The sixth lens 106 may include an eleventh surface S11 defined as an object-side surface and a twelfth surface S12 defined as a sensor-side surface. The above eleventh surface S11 may have a concave shape on the optical axis OA, and the twelfth surface S12 may have a concave shape on the optical axis OA. That is, the sixth lens 106 may have a concave shape on both sides in the optical axis OA. Alternatively, the eleventh surface S11 may have a convex shape on the optical axis OA, and the twelfth surface S12 may have a convex shape on the optical axis OA. That is, the sixth lens 106 may have a convex shape on both sides in the optical axis OA. Alternatively, the eleventh surface S11 may have a concave shape on the optical axis OA, and the twelfth surface S12 may have a convex shape on the optical axis OA. Alternatively, the eleventh surface S11 may have a convex shape with respect to the optical axis OA, and the twelfth surface S12 may have a concave shape with respect to the optical axis OA. At least one of the eleventh surface S11 and the twelfth surface S12 of the sixth lens 106 may be aspherical. For example, both the eleventh surface S11 and the twelfth surface S12 may be aspherical. The aspherical coefficients of the eleventh and twelfth surfaces S11, S12 may be represented by L6S1 and L6S2 of FIG. 6. The eleventh surface S11 and the twelfth surface S12 may be provided without a critical point from the optical axis to the end of the effective area. The center thickness CT6 of the sixth lens 106 may be thinner than the edge thickness ET6. Accordingly, the incident light can be refracted in the direction of the optical axis by the difference between the center thickness CT6 and the edge thickness ET6 of the sixth lens 106.

The seventh lens 107 may have positive (+) or negative (−) refractive power on the optical axis OA, and may have positive refractive power. The refractive power of the seventh lens 107 has a sign opposite to the sign of the refractive power of the sixth lens 106, so as to improve chromatic aberration. The seventh lens 107 may include a plastic or glass material, and may be, for example, a plastic material. The seventh lens 107 may include a thirteenth surface S13 defined as an object-side surface and a fourteenth surface S14 defined as a sensor-side surface. The thirteenth surface S13 may have a convex shape on the optical axis OA, and the fourteenth surface S14 may have a convex shape on the optical axis OA. That is, the seventh lens 107 may have a convex shape on both sides in the optical axis OA. As another example, the thirteenth surface S13 may have a convex shape on the optical axis OA, and the fourteenth surface S14 may have a concave shape on the optical axis OA. Alternatively, the thirteenth surface S13 may have a concave shape on the optical axis OA, and the fourteenth surface S14 may have a convex shape on the optical axis OA. That is, the seventh lens 107 may have a convex meniscus shape toward the sensor in the optical axis OA. Alternatively, the thirteenth surface S13 may have a concave shape on the optical axis OA, and the fourteenth surface S14 may have a concave shape on the optical axis OA. That is, the seventh lens 107 may have a concave shape on both sides in the optical axis OA.

At least one of the thirteenth surface S13 and the fourteenth surface S12 of the seventh lens 107 may be aspherical. For example, both the thirteenth surface S13 and the fourteenth surface S14 may be aspherical. Aspherical coefficients of the thirteenth and fourteenth surfaces S13, S14 may be represented by L7S1 and L7S2 of FIG. 6. The thirteenth surface S13 and the fourteenth surface S14 may be provided without a critical point from the optical axis to the end of the effective area. As another example, the thirteenth surface S13 or/and the fourteenth surface S14 of the seventh lens 107 may have a critical point between the optical axis and the end of the effective area, and the critical point is a point where the tendency of the Sag value changes. That is, the critical point is the point where the Sag value increases and then decreases on the lens surface, or the point where the Sag value decreases and then increases. The Sag value is the optical axis distance between the straight line perpendicular to the center of each lens surface and the lens surface, and the Sag value has a positive value at a position located closer to the sensor than the center of each lens surface, and a negative value at a position located closer to the object than the center of each lens surface.

The sixth lens 106 and the seventh lens 107 have refractive powers of opposite signs, and when the Abbe number difference is set to 10 or less, chromatic aberration can be controlled. Accordingly, the third lens group G3 can minimize the chromatic aberration change caused by the position changing according to the mode change and perform an achromatic role.

The eighth lens 108 can have a negative (−) refractive power at the optical axis OA. The eighth lens 108 can include a plastic or glass material, and can be, for example, a plastic material. The above eighth lens 108 may include a fifteenth surface S15 defined as an object-side surface and a sixteenth surface S16 defined as a sensor-side surface. The fifteenth surface S15 may have a convex shape on the optical axis OA, and the sixteenth surface S16 may have a concave shape on the optical axis OA. That is, the eighth lens 108 may have a meniscus shape convex from the optical axis OA toward the object side. Alternatively, the eighth lens 108 may have a concave shape on the optical axis OA, and the sixteenth surface S16 may have a convex shape on the optical axis OA. That is, the eighth lens 108 may have a meniscus shape convex from the optical axis OA toward the sensor side.

At least one of the fifteenth surface S15 and the sixteenth surface S16 of the eighth lens 108 may be aspherical. For example, both the fifteenth surface S15 and the sixteenth surface S16 may be aspherical. Aspherical coefficients of the fifteenth and sixteenth surfaces S15, S16 may be represented by L8S1 and L8S2 of FIG. 6. At least one of the fifteenth surface S15 and the sixteenth surface S16 may have a critical point from the optical axis to the end of the effective area. For example, the sixteenth surface S16 may have a critical point between the optical axis and the end of the effective area. The fifteenth surface S15 may not have a critical point. As another example, both the fifteenth surface S15 and the sixteenth surface S16 may have critical points. The center thickness CT8 of the above-mentioned eighth lens 108 may be thinner than the edge thickness ET8. Accordingly, the difference between the center thickness and the edge thickness of the above-mentioned eighth lens 108 and the light incident by the critical point of the sixteenth surface S16 may be refracted to the periphery of the image sensor 300.

The above-mentioned third lens group G3 may be closest to the image sensor 300 among the plurality oflens groups G1, G2, and G3. The above-mentioned third lens group G3 may be moved in the direction of the optical axis, and the optical axis distance BFL between the above-mentioned eighth lens 108 and the image sensor 300 may vary depending on the operation mode. Here, the BFL is the optical axis distance from the center of the sensor-side surface of the above-mentioned eighth lens 108 to the image sensor 300.

The third lens group G3 may perform a role of controlling the chief ray angle CRA. In detail, the CRA of the optical system 1000 according to the embodiment may be less than about 20 degrees, and the eighth lens 108 of the third lens group G3 may correct the chief ray angle of light incident on the image sensor 300 according to each operation mode.

The camera module according to the embodiment of the invention may include the optical system 1000 described above. The camera module may move the second and third lens groups G2 and G3 among the plurality of lens groups G1, G2, and G3 included in the optical system 1000 in the direction of the optical axis OA. The camera module may include a driving member (not shown) connected to the optical system 1000. The above driving member is arranged on the outer side of the second lens group G2 and the outer side of each of the third lens group G3, and can move in the direction of the optical axis OA according to the operation mode.

The operation mode may include a first mode that moves at a first magnification as in FIG. 2, and a third mode that operates at a second magnification different from the first magnification as in FIG. 3. At this time, the second magnification may be greater than the first magnification. In addition, the operation mode may include a second mode that has a magnification between the first and third modes as in FIG. 1. Here, the first magnification may be the lowest magnification of the optical system 1000, and the second magnification may be the highest magnification of the optical system 1000. The first magnification may be about 1.5 magnification or more, for example, about 1.5 magnification to about 5 magnifications, the second magnification may be about 6 magnifications to about 11 magnifications, and the third magnification may be about 4 magnifications to about 6 magnifications between the first and second magnifications. The first mode may be a wide mode, the second mode may be a middle mode, and the third mode may be a tele mode.

The driving member may move M1 and M2 each of the second and third lens groups G2 and G3 or operate them in an initial mode according to one operation mode selected from the first to third modes. In detail, each of the plurality of driving members is connected to the second lens group G2 and the third lens group G3, and may move the second lens group G2 or the third lens group G3 according to the operation mode. The initial mode may be one of the first, second, and third modes, for example, the second mode or the middle mode. For example, in the first mode, each of the second lens group G2 and the third lens group G3 may be positioned at a position defined as a first position (Position 1). In the second mode, each of the second lens group G2 and the third lens group G3 may be positioned at a position defined as a second position (Position 2) closer to the object than the first position. In the third mode, each of the second lens group G2 and the third lens group G3 may be positioned at a position defined as a third position (Position 3) closer to the sensor than the first position. The first position may be an area between the second and third positions.

The first position at which the second lens group G2 is positioned in the first mode may be an area between the second and third positions at which the second lens group G2 is positioned in the second and third modes. The first position at which the third lens group G3 is positioned in the first mode may be an area between the second and third positions at which the third lens group G3 is positioned in the second and third modes. Depending on the operation mode, at least one of the second lens group G2 and the third lens group G3 may move along the optical axis, and the first lens group G1 may be arranged at a fixed position. Depending on the operation mode, the second lens group G2 may move M1, and the first lens group G1 may be arranged at a fixed position. Depending on the operation mode, the third lens group G3 may move M2, and the first lens group G1 may be arranged at a fixed position. In each of the first position, the second position, and the third position according to the operation mode, the first to third lens groups G1, G2, and G3 may have a set interval from the adjacent lens groups. Accordingly, the optical system 1000 may have a constant TTL (Total track length) and a variable BFL according to the operation mode, and the effective focal length and magnification of the optical system 1000 may be controlled by controlling the positions of some lens groups. In addition, the optical axis interval DG4 between the third lens group G3 and the optical filter 500 may be variable according to the operation mode.

The effective length CA1 of the first lens 101 is the largest among the lenses, and the effective diameter CA6 of the sixth lens 106 is the smallest among the lenses. The effective length CA1 of the first lens 101 may be 5 mm or more. The effective length CA6 of the sixth lens 106 may be less than 5 mm, for example, 3.8 mm or more. In the absolute value of the focal length, the focal length F1 of the first lens 101 may be the largest among the lenses, and the difference (absolute value) of the focal length between adjacent two lenses may be the largest between the fourth and fifth lenses 104 and 105 and the smallest between the sixth and seventh lenses 106 and 107.

Among the lenses in the first lens group G1, the center thickness CT2 of the second lens 102 may be the thickest. The radius of curvature of the first to fourth surfaces S1, S2, S3, S4 of the first and second lenses 101, 102 is set to 5 mm or more, so as not to significantly change the angle of refraction of the incident light, and can be guided to the fourth lens 104 of the second lens group G2 through the third lens 103. The sum of the center thicknesses CT3, CT4 of the third and fourth lenses 103, 104 of the second lens group G2 can be greater than the sum of the center thicknesses CT1, CT2, and CT3 of the first, second, and third lenses 101, 102, 103. The sum of the center thicknesses CT3, CT4 of the third and fourth lenses 103, 104 of the second lens group G2 may be greater than the sum of the center thicknesses CT6, CT7, and CT8 of the sixth, seventh, and eighth lenses 106, 107, 108. Accordingly, the second lens group G2 may guide the light incident through the first lens group G1 to the effective area of the third lens group G3.

The optical axis distance DG12 between the first and second lens groups G1 and G2 and the optical axis distance DG23 between the second and third lens groups G2 and G3 may be at least 0.2 mm or more and at most 8 mm or less depending on the change in magnification of the operating modes. In detail, the optical axis distance DG12 between the first and second lens groups G1 and G2 can be moved by 0.2 mm or more, for example, within a range of 0.2 mm to 8 mm, and the optical axis distance DG23 between the second and third lens groups G2 and G3 can be moved by 1 mm or more, for example, within a range of 1 mm to 4 mm. In addition, the center distance DG4 between the eighth lens 108 and the optical filter 500 can be moved by 1 mm or more, for example, within a range of 1 mm to 10 mm. The relationship between DG12, DG23, and DG4 in the first, second, and third modes is as follows.

$$First mode : DG 4 < DG 23 < DG 12$$

$$Second mode : DG 23 < DG 12 < DG 4$$

$$Third mode : DG 12 < DG 23 < DG 4$$

Depending on the operation mode, the F number of the optical system 1000 provides a brightness of 2.0 or more, and the F number may be in the range of 2.2 to 3.8. The aperture may be located between the first lens group G1 and the second lens group G2.

The optical system 1000 according to the embodiment may satisfy at least one or two or more of the Equations described below. Accordingly, the optical system 1000 according to the embodiment may effectively correct aberrations that change according to a change in the operation mode. In addition, the optical system 1000 according to the embodiment can effectively provide an autofocus AF function for a subject at various magnifications, and can have a slim and compact structure. Hereinafter, the optical axis distance between two adjacent lenses can be defined as CG1-CG7, which is the distance from the distance between the first and second lenses to the distance between the seventh and eighth lenses. The effective lengths of the object-side surface and the sensor-side surface of the first lens 101 to the object-side surface and the sensor-side surface of the eighth lens 108 can be defined as CA11, CA12 to CA81, CA82. The units of the thickness, distance, radius of curvature, TTL, BFL, effective diameter, etc. are mm. In addition, the effective length can be defined as the major axis effective length or the maximum diameter when the shape of the lens surface includes a circular or non-circular shape, and the lens has a partially circular shape.

$$nL\_G2 > 1 ( nL is an integer greater than or equal to 2 ) \qquad [ Equation 1 ]$$

In Equation 1, nL_G2 means the number of lenses included in the second lens group G2. Here, nL_G1>nL_G2, nL_G3>nL_G2 may have the relationships.

$$0.7 < CA 41 / CA 11 < 1.2 \qquad [ Equation 2 ]$$

In Equation 2, CA41 is the effective length of the seventh surface S7 of the fourth lens 104, and CA11 is the effective length of the first surface S1 of the first lens 101 or the effective length in the major axis direction. When the Equation 2 is satisfied, a high entrance pupil size (EPD: Entrance Pupil Diameter, EPD) compared to the optical system can be provided. Preferably, 0.75<CA41/CA11<1 can be satisfied.

$$1 < CT 1 / CT 3 < 2 \qquad [ Equation 3 ]$$

If Equation 3 satisfies the center thickness of the first and third lenses 101, 103, the aberration characteristic in the optical system 1000 can be improved. Preferably, 1.2<CT1/CT3<1.8 can be satisfied.

$$0 < CT 1 / CT 4 < 1 \qquad [ Equation 4 ]$$

If the Equation 4 satisfies the center thickness of the first and fourth lenses 101, 104, the optical system 1000 can improve the aberration characteristic. Preferably, 0.2<CT1/CT4<0.85 can be satisfied. The center thickness CT4 of the fourth lens 104 is the thickest among the lenses and has a convex shape on both sides, so that the fourth lens 104 can improve the light incident efficiency of the first lens group G1 and refract the light into the effective area of the sixth lens 106 having the smallest effective length.

$$1.2 < ET 3 / CT 3 < 3.2 \qquad [ Equation 5 ]$$

In Equation 4, ET3 means the thickness (mm) in the direction of the optical axis OA at the edge, which is the end of the effective area of the third lens 103. When the optical system 1000 according to the embodiment satisfies the Equation 5, the optical system 1000 can improve the distortion characteristics of the light passing through the first lens group G1. Preferably, 1.2<ET3/CT3<1.6 can be satisfied.

Here, if the center thickness of the i-th lens is CT1 and the edge thickness of the i-th lens is ET1, the ratio of CT1/ET1 may be the largest when i is 4 and the smallest when i is 8. In other words, the lens with the largest difference between the center thickness and the edge thickness may be arranged as the object-side lens of the second lens group G2, and the lens with the smallest difference may be arranged as the sensor-side lens of the third lens group G3.

$$FG 1 < 0 \qquad [ Equation 6 ]$$

In Equation 6, FG1 is the effective focal length EFL of the first lens group G1, and may have a value less than 0. FG1 is the composite focal length of the first to third lenses. If Equation 6 is satisfied, the optical aberration of the optical system, i.e., the optical aberration of the first lens group G1, may be improved.

The effective focal length of the second lens group G2 is FG2, the effective focal length of the third lens is FG3, and the optical system can satisfy the following mathematical formula.

$$FG 2 * 2 < \vert FG 1 \vert \qquad [ Equation 6 - 1 ]$$

$$FG 2 < \vert FG 3 \vert < FG 2 * 3 \text{(*} is multiplication ) \qquad [ Equation 6 - 2 ]$$

$$\vert FG 3 \vert < \vert FG 1 \vert \qquad [ Equation 6 - 3 ]$$

In this way, by adjusting the focal length of each lens group, the refractive angle of light passing through the lenses can be adjusted.

$$CRA < 20 ° \qquad [ Equation 7 ]$$

In Equation 7, CRA is the principal ray incident angle, and in the optical system, the principal ray incident angle may be less than 20 degrees at most depending on the first, second, and third modes, and may be, for example, less than 15 degrees. The first mode may be a wide mode, the second mode may be a middle mode, and the third mode may be a tele mode. Here, in the case of the first mode (Wide), the principal ray incident angle may be greater than the principal ray incident angle in the case of the second mode at 1.0 field. In the case of the third mode (Tele), the principal ray incident angle may be 11 degrees or less in the case of the third mode at 1.0 field, and the principal ray incident angle of the second mode may be smaller than the principal ray incident angle of the first mode. When the Equation 6 is satisfied, the peripheral light ratio can be secured.

$$( TTL / DG 1 ) > 3.5 \qquad [ Equation 8 ]$$

In Equation 8, DG1 is the optical axis distance of the first lens group G1, for example, the optical axis distance from the center of the object-side surface of the first lens 101 to the center of the sensor-side surface of the third lens 103. For example, DG1 means the distance (mm) in the optical axis OA of the first surface S1 of the first lens 101 and the sixth surface S6 of the third lens 103. TTL (Total track length) means the distance (mm) in the optical axis OA from the object-side first surface S1 of the first lens 101 to the upper surface of the image sensor 300. When the optical system 1000 according to the embodiment satisfies the Equation 8, the optical system 1000 has a relatively small TTL and can secure a peripheral light ratio.

The Equation 8 may further include the following Equations.

$$( TTL / DG 1 ) < ( TTL / DG 2 ) \qquad [ Equation 8 - 1 ]$$

$$DG 3 < DG 2 \qquad [ Equation 8 - 2 ]$$

Here, DG2 is the optical axis distance of the second lens group G2, and is the distance from the center of the object-side surface of the fourth lens 104 to the center of the sensor-side surface of the fifth lens 105. DG3 is the optical axis distance of the third lens group G3, and is the distance from the center of the object-side surface of the sixth lens 106 to the center of the sensor-side surface of the eighth lens 108.

$$2 < TTL / EPD 3 < 7 \qquad [ Equation 9 ]$$

In Equation 9, EPD3 means the size of the entrance pupil EPD of the optical system 1000 when operating in the third mode, i.e., Tele mode. When the optical system 1000 according to the embodiment satisfies the Equation 9, the optical system 1000 can secure a bright image when operating in the third mode, and may be a minimum condition for securing an F number of 4 or less in Tele mode. Preferably, 3<TTL/EPD3<5 can be satisfied.

$$3 < TTL / EPD 1 < 7 \qquad [ Equation 9 - 1 ]$$

$$2 < TTL / EPD 2 < 7 \qquad [ Equation 9 - 2 ]$$

$$( TTL / EPD 3 ) < ( TTL / EPD 2 ) < ( TTL / EPD 1 ) \qquad [ Equation 9 - 3 ]$$

In Equations 9-1 to 9-3, EPD1 is the size of the entrance pupil of the optical system in the first mode (Wide), and EPD2 is the size of the entrance pupil of the optical system in the second mode (Middle). When the optical system satisfies the above conditions, it can secure a bright image according to each mode.

$$2 < CT\_Max / CT\_Min < 6 \qquad [ Equation 10 ]$$

In Equation 10, CT_Max is the thickest thickness among the center thicknesses of the lenses, and CT_Min is the thinnest thickness among the center thicknesses of the lenses, and when Equation 10 is satisfied, the optical system aberration characteristics can be improved. Preferably, 3<CT_Max/CT_Min<5.5 can be satisfied.

$$1 < CA\_Max / CA\_Min < 3 \qquad [ Equation 11 ]$$

In Equation 11, CA_Max is the largest effective length among each lens surface, and CA Min is the smallest effective diameter among each lens surface, and when Equation 11 is satisfied, the optical performance of the optical system can be maintained, and a camera module for a slim or compact structure can be provided. Preferably, 1<CA_Max/CA_Min<1.5 can be satisfied.

$$0.1 < \sum CG\_Wide / TTL < 0.6 \qquad [ Equation 12 ]$$

In Equation 12, 2CG is the sum of the center distances between adjacent lenses, and ECG Wide is the sum of the center distances between adjacent lenses in the first mode. When the optical system satisfies the Equation 12, the center distance DG12 between the first and second lens groups and the center distance between the second and third lens groups can be set according to the Wide mode. The center distance DG12 between the first and second lens groups can be the center distance CG3 between the third and fourth lenses 103, 104, and varies depending on the operation mode. The center distance DG23 between the second and third lens groups is the center distance CG5 between the fifth and sixth lenses 105, 106, and varies depending on the operation mode. Preferably, 0.3<ΣCG_Wide/TTL<0.5 can be satisfied.

$$0.05 < \sum CG\_Mid / TTL < 0.4 \qquad [ Equation 12 - 1 ]$$

$$0 < \sum CG\_Tele / TTL < 0.3 \qquad [ Equation 12 - 2 ]$$

In Equations 12-1 and 12-2, ΣCG_Mid is the sum of the center distances between adjacent lenses in the second mode, and ΣCG_Tele is the sum of the center distances between adjacent lenses in the third mode. When the optical system satisfies the Equations 12-1 and 12-2, the center distance DG12 between the first and second lens groups and the center distance between the second and third lens groups can be set according to the middle mode and the tele mode. Preferably, the condition of ΣCG_Tele<ΣCG_Mid<ECG Wide can be satisfied. When the optical system 1000 according to the embodiment satisfies at least one or two or more of Equations 1 to 12, the optical system 1000 can have a slim structure. In addition, the optical system 1000 can have improved assembly properties and a mechanically stable shape.

$$0.5 < DG 1 / DG 2 < 2 \qquad [ Equation 13 ]$$

In Equation 13, DG1 is the optical axis distance of the first lens group G1, and DG2 is the optical axis distance of the second lens group G2. By setting the optical axis distances of the first and second lens groups G1 and G2 in Equation 13, the TTL can be adjusted. Preferably, 0.8<DG1/DG2<1.2 can be satisfied.

$$0.5 < DG 2 / DG 3 < 2 \qquad [ Equation 14 ]$$

In Equation 14, DG2 is the optical axis distance of the second lens group G2, and DG3 is the optical axis distance of the third lens group G3. Preferably, 0.9<DG2/DG3<1.2 can be satisfied. When the optical system 1000 according to the embodiment satisfies at least one of Equation 13 and Equation 14, it has a relatively small TTL and can provide various magnifications according to at least three mode changes.

$$0 < CG 2 / TTL < 0.2 \qquad [ Equation 15 ]$$

In Equation 15, CG2 is the optical axis distance between the second lens 102 and the third lens 103. When the optical system 1000 satisfies the Equation 15, the optical system 1000 has a relatively small TTL and can have improved optical characteristics by controlling stray light incident on the first lens group G1. Preferably, 0<CG2/TTL<0.1 can be satisfied.

$$2 < TTL / ( DG 2 + DG 3 ) < 5 \qquad [ Equation 16 ]$$

The Equation 16 sets the sum of the optical axis distances of the TTL and the second and third lens groups G2, G3, and when the optical system 1000 satisfies the Equation 16, the optical system 1000 has a relatively small TTL and can improve chromatic aberration characteristics. Preferably, 2.2<TTL/(DG2+DG3)<3.5 can be satisfied.

$$20 < \vert Vd 4 - Vd 5 \vert < 70 \qquad [ Equation 17 ]$$

In Equation 17, Vd4 means the Abbe number of the fourth lens 104, and Vd5 means the Abbe number of the fifth lens 105. When the absolute value of the difference in Abbe numbers between the fourth and fifth lenses of the optical system 1000 according to the embodiment satisfies the Equation 17, the optical system 1000 can improve the chromatic aberration characteristics. Preferably, Vd5<Vd4 is satisfied, and 60<Vd4 can be satisfied.

$$15 < \vert Vd 8 - Vd 7 \vert < 60 \qquad [ Equation 18 ]$$

In Equation 18, Vd8 means the Abbe number of the eighth lens, and Vd7 means the Abbe number of the seventh lens. If the absolute value of the difference in Abbe numbers of the seventh and eighth lenses satisfies the Equation 18, the optical system 1000 can improve chromatic aberration characteristics. Preferably, it satisfies Vd7<Vd8 and 40<Vd8<Vd4.

$$1.6 < Nd 1 \qquad [ Equation 19 ]$$

In Equation 19, Nd1 means the refractive index of the d-line of the first lens 101. If the optical system 1000 according to the embodiment satisfies the Equation 19, it can disperse the incident light and secure the effective area of the lens arranged after the first lens 101. Preferably, it can satisfy 1.7<Nd1.

$$1.6 < Nd 2 \qquad [ Equation 19 - 1 ]$$

$$1.6 < Nd 7 \qquad [ Equation 19 - 2 ]$$

The refractive indices of the fourth and eighth lenses 104, 108 may be less than 1.6, and the refractive indices of the fourth lens 104 may be the smallest among the lenses. The number of lenses having a refractive index of 1.63 or higher among the lenses is 2 or more, for example, 3 or more.

$$1 < L 1 R 1 / L 3 R 2 < 3.5 \qquad [ Equation 20 ]$$

In the mathematical formula 20, L1R1 means the radius of curvature of the object-side first surface S1 of the first lens 101, and L3R2 means the radius of curvature of the sensor-side sixth surface S6 of the third lens 103. When the optical system 1000 according to the embodiment satisfies the Equation 20, the optical system 1000 can control stray light incident on the first lens group G1. Preferably, 2<L1R1/L3R2<3 can be satisfied. Since the third lens 103 has a sensor-side surface having a concave shape on the optical axis, the effective diameter of the fourth lens 104 can be suppressed from increasing.

$$1.5 < L 1 R 1 / L 4 R 1 < 3.5 \qquad [ Equation 21 ]$$

In Equation 21, L1R1 means the radius of curvature of the object-side first surface S1 of the first lens 101, and L4R1 means the radius of curvature of the object-side seventh surface S7 of the fourth lens 104. When the optical system 1000 according to the embodiment satisfies the Equation 21, the optical system 1000 can have good optical performance at various magnifications. Preferably, 2<L1R1/L4R1<3 can be satisfied.

$$0 < L 3 R2 / L 4 R 1 < 2 \qquad [ Equation 22 ]$$

In Equation 22, L3R2 means the radius of curvature of the sensor-side sixth surface S6 of the third lens 103, and L4R1 means the radius of curvature of the object-side seventh surface S7 of the fourth lens 104. When the optical system 1000 according to the embodiment satisfies the Equation 22, the optical system 1000 can have good optical performance in the periphery of the field of view (FOV) when operating at various magnifications of at least three modes. Preferably, 0.5<L3R2/L4R1<1.5 can be satisfied. The fourth lens 104 is the first lens of the second lens group G2, has a convex shape on both sides on the optical axis, and can have positive power. Accordingly, the distance between the convex sensor-side surface of the fourth lens 104 and the concave object-side surface of the fifth lens 105 can be tightly closed.

$$1 < L 1 R 1 / L 8 R 2 < 3 \qquad [ Equation 23 ]$$

In Equation 23, L8R2 means the radius of curvature of the sensor-side sixteenth surface S16 of the eighth lens 108. When the optical system 1000 satisfies the Equation 23, the optical system 1000 can have good optical performance at the center and periphery of the field of view (FOV). Preferably, 2<L1R1/L8R2<3 can be satisfied.

$$0 < Md12\_mG2 / TTL < 0.5 \qquad [ Equation 24 ]$$

In Equation 24, Md12_mG2 means the difference in the center distance (unit: mm) after the movement of the second lens group G2 when changing from the second mode to the first mode or from the first mode to the second mode. In detail, the Md12_mG2 represents the movement distance of the second lens group G2 in the first and second modes, and means the difference value between the optical axis distance between the first and second lens groups G1 and G2 in the first mode and the optical axis distance between the first and second lens groups G1 and G2 in the second mode. When the optical system 1000 according to the embodiment satisfies the Equation 24, the optical system 1000 can minimize the movement distance of the second lens group G2 when the magnification is changed, so that the optical system 1000 can have a slim structure. In addition, the movement distance can be minimized when the position of the second lens group G2 is controlled, so that it can have improved power consumption characteristics. Preferably, 0<Md12 mG2/TTL<0.2 can be satisfied.

$$0 < Md23\_mG2 / TTL < 0.5 \qquad [ Equation 25 ]$$

In the Equation 25, Md23_mG2 means the difference in the center distance (unit: mm) after the movement of the second lens group G2 when operating from the second mode to the third mode, or from the third mode to the second mode. In detail, Md23_mG2 means the difference value between the optical axis distance between the first and second lens groups G1 and G2 in the second mode and the optical axis distance between the first and second lens groups G1 and G2 in the third mode. The maximum movement distance of the second lens group G2 may be greater than the maximum movement distance of the third lens group G3. When the optical system 1000 according to the embodiment satisfies the Equation 25, the optical system 1000 can minimize the movement distance of the second lens group G2 when the magnification is changed, so that the optical system 1000 can have a slim structure. In addition, since the movement distance can be minimized when controlling the position of the second lens group G2, it can have improved power consumption characteristics. It can satisfy 0<Md23_mG2/TTL<0.1. In addition, it can satisfy the condition of Md23_mG2<Md12_mG2.

$$0.3 < Md12\_mG2 / DG 2 < 1 \qquad [ Equation 26 ]$$

The Equation 26 can set the movement distance of the second lens group G2 and the optical axis distance of the second lens group G2. When the optical system 1000 satisfies the Equation 26, the optical system 1000 can minimize the movement distance of the second lens group G2 when the magnification is changed, so the optical system 1000 can have a slim structure. In addition, the movement distance can be minimized when controlling the position of the second lens group G2, so that it can have improved power consumption characteristics.

$$0 < Md23\_mG3 / DG 3 < 0.5 \qquad [ Equation 27 ]$$

In Equation 27, Md23_mG3 means the difference in the center distance after the movement of the third lens group G3 when changing from the second mode to the third mode or from the third mode to the second mode. When the optical system 1000 satisfies the Equation 27, the optical system 1000 can minimize the movement distance of the third lens group G3 when the magnification is changed, so that the optical system 1000 can have a slim structure. In addition, the movement distance can be minimized when controlling the position of the third lens group G3, so that it can have improved power consumption characteristics. Preferably, 0.1<Md23_mG3/DG3<0.4 can be satisfied.

$$1 < ( CT 1 / ET 1 ) / ( CT 3 / ET 3 ) < 5 \qquad [ Equation 28 ]$$

In Equation 28, CT1/ET1 is a value obtained by dividing the thickness of the optical axis of the first lens 101 by the thickness at the end, and CT3/ET3 is a value obtained by dividing the thickness of the optical axis of the third lens 103 by the thickness at the end. If the value obtained by dividing the center thickness and the end thickness of the first and third lenses 101, 103 satisfies the Equation 28 at the above ratio, chromatic aberration can be improved and incident light can be controlled. Preferably, 1< (CT1/ET1)/(CT3/ET3)<2 can be satisfied.

$$0 < ( CT 1 / ET 1 ) / ( CT 7 / ET 7 ) < 1 \qquad [ Equation 29 ]$$

In Equation 29, CT1/ET1 is a value obtained by dividing the thickness of the seventh lens 107 at the optical axis by the thickness at the end. If the values obtained by dividing the center thickness and the end thickness of the first and seventh lenses 101, 107 satisfy the Equation 29 at the above ratio, chromatic aberration can be improved and incident light can be controlled. Preferably, 0.2< (CT1/ET1)/(CT7/ET7)<0.7 can be satisfied.

$$1 < Md 1 ( DG 12 / DG 23 ) < 5 \qquad [ Equation 30 ]$$

In Equation 30, Md1 (DG12/DG23) represents a ratio between the center distance DG12 between the first and second lens groups in the first mode and the center distance DG23 between the second and third lens groups. When the optical system 1000 according to the embodiment satisfies the Equation 30, the optical system 1000 may have improved optical characteristics at the first magnification. In detail, the optical system 1000 may have improved aberration characteristics at the first magnification and may improve optical performance at the center and periphery of the field of view (FOV). Preferably, 1<Md1 (DG12/DG23)<3 may be satisfied.

$$0 < Md 3 ( DG 12 / DG 23 ) < 0.7 \qquad [ Equation 31 ]$$

In Equation 31, Md3 (DG12/DG23) represents a ratio between the center distance DG12 between the first and second lens groups in the third mode and the center distance DG23 between the second and third lens groups. When the optical system 1000 according to the embodiment satisfies the Equation 31, the optical system 1000 may have improved optical characteristics at the second magnification. In detail, the optical system 1000 may have improved aberration characteristics at the second magnification and may improve optical performance at the periphery of the field of view (FOV). Preferably, 0<Md3 (DG12/DG23)<0.5 may be satisfied.

$$0.5 < TD 2 / TTL < 1 \qquad [ Equation 32 ]$$

In Equation 32, TD2 is an optical axis distance from the center of the object-side surface of the first lens to the center of the sensor-side surface of the eighth lens in the second mode. When the optical system 1000 according to the embodiment satisfies the Equation 32, the optical system 1000 may have improved optical characteristics in the middle mode, which is the second mode. In detail, the optical system 1000 may have improved aberration characteristics in the middle mode and may improve optical performance in the peripheral portion of the field of view (FOV).

$$1 < TD 1 / TD 2 < 1.5 \qquad [ Equation 33 ]$$

In Equation 33, TD1 is an optical axis distance from the center of the object-side surface of the first lens to the center of the sensor-side surface of the eighth lens in the first mode. When the optical system 1000 according to the embodiment satisfies the Equation 33, the optical system 1000 can have improved optical characteristics in the first and second modes and can reduce the influence on TTL. In detail, the optical system 1000 can have improved aberration characteristics in the first and second modes and can improve the optical performance of the peripheral part of the field of view (FOV). Preferably, 1<TD1/TD2<1.4 can be satisfied.

$$0.5 < TD 1 / TTL < 1 \qquad [ Equation 33 - 1 ]$$

Preferably, 0.5<TD1/TTL<1 can be satisfied. The relationship between the maximum optical axis distance TD1 and TTL according to each mode can be set.

$$1 < TD 1 / TD 3 < 1.5 \qquad [ Equation 33 - 2 ]$$

In Equation 33-2, TD3 is the optical axis distance from the center of the object-side surface of the first lens to the center of the sensor-side surface of the eighth lens in the third mode. The optical system 1000 can have improved optical characteristics in the first and third modes, and can reduce the influence on TTL.

$$10 mm < TD 3 < TD 2 < TD 1 < 20 mm \qquad [ Equation 34 ]$$

The Equation 34 is a drawing comparing the optical axis distances of lenses in the first, second, and third modes, and TD3 is the optical axis distance from the center of the object-side surface of the first lens to the center of the sensor-side surface of the eighth lens in the third mode. When the optical system 1000 according to the embodiment satisfies the Equation 34, the optical system 1000 can have improved optical characteristics in the first, second, and third modes. In detail, the optical system 1000 can have improved aberration characteristics in the first, second, and third modes and improve optical performance in the periphery of the field of view (FOV).

$$0.1 < BFL 2 / TTL < 1 \qquad [ Equation 35 ]$$

In Equation 35, BFL2 (Back focal length1) is an optical axis distance from the center of the sensor-side surface of the eighth lens to the upper surface of the image sensor in the second mode. When the optical system 1000 according to the embodiment satisfies the Equation 35, the optical system 1000 can adjust the focus position to the upper surface of the image sensor 300 in the second mode. In detail, the optical system 1000 has improved optical characteristics in the second mode and can improve the optical performance of the peripheral part of the field of view (FOV). Preferably, it can satisfy 0.2<BFL2/TTL<0.5.

$$2 < BFL 3 / BFL 1 < 4 \qquad [ Equation 36 ]$$

In Equation 36, BFL3 is an optical axis distance from the center of the sensor-side surface of the eighth lens to the upper surface of the image sensor in the third mode. When the optical system 1000 according to the embodiment satisfies the Equation 36, the optical system 1000 can adjust the focus position to the upper surface of the image sensor 300 in the first and third modes. In detail, the optical system 1000 has improved optical characteristics in the first and third modes and can improve the optical performance of the peripheral part of the field of view (FOV). Preferably, 2.5<BFL3/BFL1<3.1 can be satisfied.

$$1 < TD 3 / BFL 3 < 3 \qquad [ Equation 37 ]$$

The Equation 37 is a value comparing the optical axis distance TD3 between the center of the object-side surface of the first lens and the center of the sensor-side surface of the eighth lens in the third mode, and the optical axis distance BFL3 from the center of the sensor-side surface of the eighth lens 108 to the upper surface of the image sensor. When the optical system 1000 according to the embodiment satisfies the Equation 37, the optical system 1000 can have improved optical characteristics in the third mode. In detail, the optical system 1000 can have improved aberration characteristics in the third mode and improve optical performance in the periphery of the field of view (FOV). Preferably, 1.3<TD3/BFL3<2.1 can be satisfied.

$$2 < Md\_CG \_Max / Md\_CG \_Min < 8 \qquad [ Equation 38 ]$$

In Equation 38, Md_CG_Max means the maximum center distance among the center distances between the first to eighth lenses in the first, second, and third modes, and Md CG Min means the minimum center distance among the center distances between the first to eighth lenses in the first, second, and third modes. When the optical system satisfies the Equation 38, the optical axis distances of the TTL and lenses according to each mode can be adjusted. Preferably, 4<Md_CG_Max/Md_CG Min<7 can be satisfied.

$$1 mm < BFL 1 < 6 mm \qquad [ Equation 39 ]$$

The Equation 39 represents the optical axis distance between the eighth lens and the image sensor in the first mode. When the optical system satisfies the Equation 39, the focus position toward the top surface of the image sensor in the first mode can be adjusted. Preferably, it can include 2 mm<BFL1<3.5 mm.

$$30 < Aver\_Vd < 50 \qquad [ Equation 40 ]$$

In Equation 40, Aver_Vd is the average of Abbe numbers of the first to eighth lenses. When the optical system satisfies the Equation 40, the optical system 1000 can have improved aberration characteristics and resolution. Preferably, it can satisfy 34<Aver Vd<52.

$$1.5 < Aver\_Vd < 1.8 \qquad [ Equation 41 ]$$

In Equation 40, Aver_Nd is the average of refractive indices of the first to eighth lenses. When the optical system satisfies the Equation 41, the optical system 1000 can have improved aberration characteristics and resolution. Preferably, 1.6<Aver_Nd<1.7 can be satisfied.

$$10 < \sum Vd / \sum Nd < 40 \qquad [ Equation 41 - 1 ]$$

In Equation 41-1, Vd means the sum of the Abbe numbers of each of the plurality of lenses. ΣNd means the sum of the refractive indices of each of the plurality of lenses. When the optical system 1000 according to the embodiment satisfies the Equation 41-1, the optical system 1000 can have improved aberration characteristics and resolution. Preferably, Equation 41-1 can satisfy 17<ΣVd/ΣNd<25. Preferably, the condition of (ΣVd−ΣNd)<290 can be satisfied.

$$2 < \vert FG 1 / FG 2 \vert < 4 \qquad [ Equation 42 ]$$

In Equation 42, FG1 represents the effective focal length EFL of the first lens group G1, and FG2 represents the effective focal length of the second lens group G2. FG2 is the composite focal length of the fourth and fifth lenses. If the Equation 42 is satisfied, the size of the optical system, for example, the total track length TTL, can be reduced. Preferably, FG2>0 is satisfied. FG3 is the composite focal length of the sixth to eighth lenses, and FG3<0, and the condition of |FG1|>|FG3|>FG2 can be satisfied. Preferably, 2<| FG1/FG2|<3.5 can be satisfied.

$$1 < \vert FMd 2 / FMd 1 \vert < 10 \qquad [ Equation 43 ]$$

In Equation 43, FMd1 is the effective focal length of the optical system in the first mode, and FMd2 is the effective focal length of the optical system in the second mode. Preferably, 1<FMd2/FMd1<3 can be satisfied. When the optical system satisfies the Equation 43, the effective focal length can be adjusted according to the first and second modes.

$$1 < \vert FMd 3 / FMd 2 \vert < 10 \qquad [ Equation 43 - 1 ]$$

In Equation 43, FMd3 is the effective focal length of the optical system in the third mode. Preferably, 1<FMd3/FMd2<2 can be satisfied, and the condition of (FMd3/FMd1)> (FMd3/FMd2) can be satisfied. If the optical system satisfies the Equation 43-1, the effective focal length can be adjusted according to the second and third modes.

In the first mode, the effective focal length Fmd1 of the optical system and the focal length of each lens can satisfy the following conditions.

$$2 < \vert F 1 / Fmd 1 \vert < 7 \qquad Condition 1$$

$$1.5 < F 2 / Fmd 1 < 4 \qquad Condition 2$$

$$0.6 < \vert F 3 / Fmd 1 \vert < 1.6 \qquad Condition 3$$

$$0 < F 4 / Fmd 1 < 1 \qquad Condition 4$$

$$2 < \vert F 5 / Fmd 1 \vert < 4 \qquad Condition 5$$

$$0.5 < \vert F 6 / Fmd 1 \vert < 1.5 \qquad Condition 6$$

$$0.5 < F 7 / Fmd 1 < 1.5 \qquad Condition 7$$

$$0.6 < \vert F 8 / Fmd 1 \vert < 1.6 \qquad Condition 8$$

The effective focal length Fmd2 of the optical system in the second mode and the focal length of each lens are the following conditions can be satisfied.

$$0 < \vert F 1 / Fmd 2 \vert < 1 \qquad Condition 1$$

$$1 < F 2 / Fmd 2 < 4 \qquad Condition 2$$

$$1 < \vert F 3 / Fmd 2 \vert < 2 \qquad Condition 3$$

$$2 < F 4 / Fmd 2 < 4 \qquad Condition 4$$

$$0 < \vert F 5 / Fmd 2 \vert < 1 \qquad Condition 5$$

$$1 < \vert F 6 / Fmd 2 \vert < 3 \qquad Condition 6$$

$$1 < F 7 / Fmd 2 < 3 \qquad Condition 7$$

$$1 < \vert F 8 / Fmd 2 \vert < 3 \qquad Condition 8$$

In the third mode, the effective focal length Fmd3 of the optical system and the focal length of each lens can satisfy the following conditions.

$$0 < \vert F 1 / Fmd 3 \vert < 1 \qquad Condition 1$$

$$0.8 < F 2 / Fmd 3 < 2 \qquad Condition 2$$

$$1 < \vert F 3 / Fmd 3 \vert < 2.5 \qquad Condition 3$$

$$3 < F 4 / Fmd 3 < 6 \qquad Condition 4$$

$$0 < \vert F 5 / Fmd3 \vert < 1 \qquad Condition 5$$

$$1 < \vert F 6 / Fmd 3 \vert < 3 \qquad Condition 6$$

$$1 < F 7 / Fmd 3 < 3 \qquad Condition 7$$

$$1.2 < \vert F 8 / Fmd 3 \vert < 3.2 \qquad Condition 8$$

$$2 < FMd 2 / EPD 2 < 7 \qquad [ Equation 44 ]$$

In Equation 44, FMd2 is an effective focal length of the optical system in the second mode (Middle), and EPD2 means the size of the entrance pupil EPD of the optical system 1000 in the second mode. When the optical system 1000 according to the embodiment satisfies the Equation 44, the optical system 1000 can secure a bright image when operating in the second mode. Preferably, 2<FMd2/EPD2<4 can be satisfied.

$$0.1 < FMd 1 / EPD 1 < 3 \qquad [ Equation 45 ]$$

In Equation 34, FMd1 is the effective focal length of the optical system in the first mode (Wide), and EPD1 means the size of the entrance pupil EPD of the optical system 1000 when the first mode is operated. When the optical system 1000 according to the embodiment satisfies the Equation 45, the optical system 1000 can secure a bright image when the first mode is operated. Preferably, 1<FMd1/EPD1<3 can be satisfied.

$$FMd 1 < FMd 2 < FMd 3 \qquad [ Equation 46 ]$$

In Equation 46, FMd1, FMd2, and FMd3 mean the effective focal lengths of the optical system in the first, second, and third modes. The effective focal length in the third mode may be the largest, and the effective focal length in the first mode may be the smallest.

$$0 < TTL / FMd 2 < 2 \qquad [ Equation 47 ]$$

The Equation 47 can adjust the TTL by comparing the effective focal length in the TTL and the second mode. Preferably, 1<TTL/FMd2<2 can be satisfied.

$$0.1 < TTL / FMd 1 < 5 \qquad [ Equation 48 ]$$

The Equation 47 can adjust the TTL by comparing the effective focal length in the TTL and the first mode. Preferably, 1<TTL/FMd1<3 can be satisfied.

$$1 < CA\_Max / ImgH < 3 \qquad [ Equation 49 ]$$

In Equation 49, CA_Max means the largest effective length CA among the lens surfaces of the plurality of lenses included in the optical system 1000. ImgH is the distance from the 0 field area of the image sensor 300 centering on the image surface overlapping the optical axis OA to the 1.0 field area of the image sensor 300. The ImgH means ½ of the maximum diagonal length of the effective area of the image sensor 300. When the optical system 1000 according to the embodiment satisfies the Equation 49, the optical system 1000 can be provided in a slim and compact manner. In addition, the optical system 1000 can implement high resolution and high quality. The range of the ImgH is 2 mm or more, for example, 2 mm to 3 mm.

Here, the effective lengths CA1-CA8 of the first to eighth lenses 101-108 can satisfy the following conditions.

$$0.5 < CA 1 / ( Imgh * 2 ) < 1.5 \qquad Condition 1$$

Preferably, CA1> (Imgh*2) can be satisfied.

$$0.4 < CA 2 / ( Imgh * 2 ) < 1.4 \qquad Condition 2$$

Preferably, CA2< (Imgh*2) can be satisfied.

And, CA3< (Imgh*2), CA4< (Imgh*2), CA5< (Imgh*2), CA6< (Imgh*2), CA7< (Imgh*2), and CA8< (Imgh*2) can be satisfied.

If the effective length of the object-side surface of the first lens 101 is CA11 and the effective length of the sensor-side surface is CA12, the following conditions may be satisfied.

$$1 < CA 11 / ( Imgh * 2 ) < 1.5 \qquad Condition 1$$

$$0.5 < CA 12 / ( Imgh * 2 ) < 1 \qquad Condition 2$$

$$5 < TTL / ImgH < 12 \qquad [ Equation 50 ]$$

If the optical system 1000 satisfies the Equation 39, the optical system 1000 may have a smaller TTL, so that the optical system 1000 may be provided in a slim and compact manner. Preferably, the range may be 6<TTL/ImgH<10.

$$1 < BFL 2 / ImgH < 3 \qquad [ Equation 51 ]$$

If the optical system 1000 according to the embodiment satisfies the Equation 51, the BFL required for a small image sensor of less than 1 inch can be secured. In addition, if the optical system 1000 satisfies the Equation 51, the optical system 1000 can operate at various magnifications while maintaining TTL, and can have excellent optical characteristics at the center and periphery of the field of view (FOV). Preferably, it can be in the range of 2<BFL2/ImgH<3.

$$2 < BFL 3 / ImgH < 4 \qquad [ Equation 52 ]$$

If the optical system 1000 according to the embodiment satisfies the Equation 52, the BFL required for a small image sensor of less than 1 inch can be secured. When the optical system 1000 satisfies the Equation 52, the optical system 1000 can operate at various magnifications while maintaining TTL, and can have excellent optical characteristics at the center and periphery of the field of view (FOV). Preferably, 2.5<BFL3/ImgH<3.5 can be satisfied.

$$1 < EPD 1 < EPD 2 < EPD 3 < 7 \qquad [ Equation 53 ]$$

In Equation 53, EPD1, EPD2, and EPD3 represent the entrance pupil sizes of the optical system according to the first to third modes, and can adjust the brightness according to each mode.

$$0 < Max\_Distortion < 3 \qquad [ Equation 54 ]$$

In Equation 54, distortion means the maximum value or maximum value of distortion from the center (0.0F) of the image sensor to the diagonal end (1.0F) based on the optical characteristics detected by the image sensor 300. When the optical system 1000 satisfies the Equation 54, the optical system 1000 can improve the distortion characteristics and set conditions for image processing. Preferably, Max_Distortion<1.5 can be satisfied.

$$8 ° < FOV 3 < FOV 2 < FOV 1 < 45 ° \qquad [ Equation 55 ]$$

In Equation 55, FOV1, FOV2, and FOV3 mean the diagonal field of view of the optical system in the first, second, and third modes. FOV (Field of view) means the angle of view (Degree) in the diagonal direction of the optical system 1000, and can provide an optical system of less than 45 degrees.

In addition, the relationship between the angle of view FOV1, FOV2, FOV3 according to each mode and the optical axis distance BFL1, BFL2, BLF3 between the last lens and the image sensor 300 can satisfy the following conditions.

$$5 < FOV 1 / BFL 1 < 15 \qquad [ Equation 56 ]$$

$$2.5 < FOV 2 / BFL 2 < 5$$

$$1 < FOV 3 / BFL 3 < 2.5$$

$$Z = \frac{{cY}^{Z}}{1 + \sqrt{1 - ( 1 + K ) {c}^{2} {Y}^{Z}}} + {AY}^{4} + {BY}^{6} + {CY}^{8} + {DY}^{10} + {EY}^{12} + {FY}^{14} + …$$

In Equation 56, Z may mean a distance in the direction of the optical axis from an arbitrary position on the aspherical surface to the vertex of the aspherical surface with Sag. In addition, Y may mean a distance in the direction perpendicular to the optical axis from an arbitrary position on the aspherical surface to the optical axis. In addition, c may mean the curvature of the lens, and K may mean the conic constant. In addition, A, B, C, D, E, and F may mean aspheric constants.

The optical system 1000 according to the embodiment may satisfy at least one of the above-described Equations 1 to 55. Accordingly, the optical system 1000 and the camera module may have improved optical characteristics. In detail, since the optical system 1000 satisfies at least one or more of the Equations 1 to 55, it can effectively compensate for optical characteristic degradation such as chromatic aberration, vignetting, diffraction effect, and deterioration of image quality in the peripheral area caused by movement of the lens group. In addition, the optical system 1000 according to the embodiment can significantly reduce the movement distance of the lens group and provide an autofocus AF function for various magnifications with excellent power consumption characteristics.

Since the optical system 1000 according to the embodiment satisfies at least one or more of the Equations 1 to 55, it can have improved assembly properties and a mechanically stable form, and it can be provided with a slim structure, so that the optical system 1000 and the camera module including it can have a compact structure.

Hereinafter, the optical system 1000 according to the embodiment and the first to third mode changes will be described in more detail. According to an embodiment, the optical system 1000 may be such that the first lens group G1 may be fixed, and the second lens group G2 and the third lens group G3 may be moved according to an operation mode. The first lens group G1 may include three lenses, for example, the first to third lenses 101, 102, 103, and the second lens group G2 may include two lenses, for example, the fourth and fifth lenses 104, 105. In addition, the third lens group G3 may include three lenses, for example, the sixth to eighth lenses 106, 107, 108.

In the optical system 1000 according to the embodiment, the object-side surface (the seventh surface S7) of the fourth lens 104 may function as an aperture, and the optical filter 500 described above may be arranged between the fourth lens group G4 and the image sensor 300.

FIG. 5 illustrates the radius of curvature (Radius of Curvature) of the optical axis OA of the first to eighth lenses 101-108, the center thickness CT of the lenses, adjacent components such as the center distance CG between the lenses, the refractive index (Refractive index) at the d-line, the Abbe number, and the effective length CA. In FIG. 5, DG4 is the optical axis distance between the eighth lens and the optical filter 500, and may vary depending on the movement of the third lens group G3.

TABLE 1

| Lens groups | Lenses | CT/ETs |
|---|---|---|
| First lens group | First lens | 0.965 |
| | Second lens | 1.159 |
| | Third lens | 0.699 |
| Second lens group | Fourth lens | 2.48 |
| | Fifth lens | 0.914 |
| Third lens group | Sixth lens | 0.83 |
| | Seventh lens | 1.958 |
| | Eighth lens | 0.52 |

Referring to Table 1, the ratios CT/ET of the center thickness CT and edge thickness ET of each lens of the plurality of lenses may be different from each other, and the CT/ET value of the fourth lens 104 may be the largest, and the CT/ET value of the eighth lens may be the smallest.

As shown in FIGS. 1 and 2, the Abbe number Vd4 of the fourth lens 104 included in the second lens group G2 may be 30 or more or 40 or more higher than the Abbe number Vd5 of the fifth lens 105. Since the fourth lens 104 and the fifth lens 105 have the above-described difference in Abbe numbers, the change in chromatic aberration that occurs when the magnification changes according to the movement M1 of the second lens group G2 may be minimized. As shown in FIGS. 1 and 3, the Abbe number Vd8 of the eighth lens 108 included in the third lens group G3 may be 20 or more or 30 or more higher than the Abbe number Vd7 of the seventh lens 107. Since the seventh lens 107 and the eighth lens 108 have the above-described Abbe number difference, the chromatic aberration change that occurs when the magnification changes according to the movement M2 of the third lens group G3 can be minimized and/or compensated to perform an achromatic function.

The camera module according to the embodiment can obtain information about the subject at various magnifications. In detail, the driving member can control the positions of the second lens group G2 and the third lens group G3, and through this, the camera module can operate at various magnifications. For example, referring to FIG. 1, FIG. 8, and FIG. 11, the camera module including the optical system 1000 can operate in the first mode having the first magnification. The first magnification can be about 3 to about 5 times. In detail, in the embodiment, the first magnification can be about 3.5 times. In the above first mode, each of the second lens group G2 and the third lens group G3 can be moved to a set position. Accordingly, each of the first to third lens groups G3 can be arranged at a set interval. For example, the second lens group G2 can be positioned in an area spaced apart from the first lens group G1 by a first interval DG12, and the third lens group G3 can be positioned in an area spaced apart from the second lens group G2 by a second interval DG23. Here, the first to second intervals DG12, DG23 can mean intervals between the lens groups on the optical axis OA, and can vary depending on the operation mode.

When the camera module operates in the first mode, the optical system 1000 can have a TTL (Total track length) value and a BFL1 value at the first position. In addition, the optical system 1000 can have FMD1 defined as a first effective focal length EFL at the first position. In addition, the field of view (FOV) of the camera module in the first mode can be less than about 35 degrees, and the F-number can be less than about 3. When the camera module operates in the second mode, the optical system 1000 can have a TTL (Total track length) value and a BFL2 value at the second position. In addition, the optical system 1000 can have FMD2 defined as a second effective focal length EFL at the second position. In addition, the field of view (FOV) of the camera module in the second mode can be less than about 25 degrees, and the F-number can be less than about 3.4. When the camera module operates in the third mode, the optical system 1000 can have a TTL (Total track length) value and a BFL3 value at the third position. In addition, the optical system 1000 may have FMD3 defined as a third effective focal length EFL at the third position. In addition, in the third mode, the angle of view (FOV) of the camera module may be less than about 20 degrees, and the F-number may be less than about 4.

As shown in FIG. 6, the relative illumination RI in each mode may vary depending on the height of the image sensor, and it can be seen that the relative illumination at the periphery or edge (1.0 Field) at the height (Field Height) of the image sensor is 50% or more. The optical system 1000 may have excellent aberration characteristics as shown in FIG. 8 and FIG. 11 in the first mode. In detail, FIG. 8 is a graph of diffraction MTF characteristics of the optical system 1000 operating in the first mode (first magnification), and FIG. 11 is a graph of aberration characteristics. The diffraction MTF characteristic graph is measured in units of about 0.252 mm from a spatial frequency range of 0.000 mm to 2.2520 mm. In the diffraction MTF graph, T represents the MTF change in spatial frequency per millimeter of the tangential, and R represents the MTF change in spatial frequency per millimeter of the radial. Here, the MTF depends on the spatial frequency of the cycle per millimeter.

In the aberration graph of FIG. 11, it is a graph measuring spherical aberration (Longitudinal Spherical Aberration), astigmatic field curves, and distortion from the left to the right. In FIG. 8, the X-axis can represent the focal length (mm) and distortion (%), and the Y-axis can mean the height of the image. In addition, the graph for spherical aberration is a graph for light in wavelength bands of about 435 nm, about 486 nm, about 546 nm, about 587 nm, and about 656 nm, and the graph for astigmatism and distortion aberration is a graph for light in wavelength band of 546 nm. In the aberration diagram of FIG. 11, it can be interpreted that the closer each curve is to the Y-axis, the better the aberration correction function is. Referring to FIG. 11, it can be seen that the optical system 1000 according to the embodiment has measurement values close to the Y-axis in almost all areas.

Table 2 and FIG. 3 are about the items of the mathematical formulas described above in the optical system 1000 of the embodiment, including the TTL (Total track length) (mm), BFL (Back focal length), effective focal length F (mm), ImgH (mm), effective length CA (mm), thickness (mm), TTL (mm), TD (mm), which is the optical axis distance from the first surface S1 to the fourteenth surface S14, the focal lengths F1, F2, F3, F4, F5, F6, F7, F8 (mm) of each of the first to seventh lenses, the sum of the refractive indices of each lens, the sum of the Abbe numbers of each lens, the sum of the center thicknesses of each lens (mm), the sum of the center distances between adjacent lenses, the effective diameter, the diagonal angle of view (FOV) (Degree), the edge thickness ET, the focal lengths (mm) of the first and second lens groups, and the F number, etc.

TABLE 2

| Items | Embodiment | Items | Embodiment |
|---|---|---|---|
| F1 | −49.777 | ET1 | 1.080 |
| F2 | 25.729 | ET2 | 1.444 |
| F3 | −11.081 | ET3 | 1.002 |
| F4 | 4.862 | ET4 | 0.828 |
| F5 | −30.840 | ET5 | 2.180 |
| F6 | −9.221 | ET6 | 1.541 |
| F7 | 9.393 | ET7 | 0.401 |
| F8 | −10.778 | ET8 | 0.961 |
| FG1 | 9.9 | ΣCG_Wide | 8.852 |
| FG2 | 15.130 | ΣCG_Mid | 5.414 |
| FG3 | 19.8 | ΣCG_Tele | 3.752 |
| ΣIndex | 13.136 | ImgH | 2.520 |
| ΣAbbe | 298.368 | TTL | 21.804 |
| ΣCT | 10.024 | | |

Table 3 illustrates the center distance between the first and second lens groups according to the first to third modes, the center distance between the second and third lens groups, the center distance between the eighth lens and the optical filter DG4, the effective focal length EFL according to each mode, the entrance pupil size EPD according to each mode, the optical axis distance TD of the lens according to each mode, the F number and angle of view, and the BFL according to each mode.

TABLE 3

| Items | First mode | Second mode | Third mode |
|---|---|---|---|
| DG12 (mm) | 4.964 | 2.356 | 0.573 |
| DG23 (mm) | 2.473 | 1.643 | 1.764 |
| DG4 (mm) | 1.829 | 5.166 | 6.829 |
| EFL(FMD1/FMD2/ | 9.9 | 15.1303 | 19.8 |
| FMD3)(mm) | | | |
| EPD(EPD1/EPD2/EPD3) | 4.3797 | 5.1156 | 5.6503 |
| TD(TD1/TD2/TD3)(mm) | 18.875 | 15.437 | 13.775 |
| F-number | 2.453 | 3.246 | 3.796 |
| FOV (degree) | 31.1466 | 20.4748 | 15.64 |
| BFL | 2.929 | 6.368 | 8.029 |
| (BFL1/BFL2/BFL3)(mm) | | | |

Table 4 and Table 5 are results for the Equations 1 to 55 described above in the optical system 1000 of the embodiment. Referring to Table 5, it can be seen that the optical system 1000 satisfies at least one, two or more, or three or more of the Equations 1 to 55. In detail, it can be seen that the optical system 1000 according to the embodiment satisfies all of the Equations 1 to 55. Accordingly, the optical system 1000 can have good optical performance and excellent optical characteristics at the center and periphery of the field of view (FOV).

TABLE 4

| | |
|---|---|
| Equations | Embodiment |

| | | |
|---|---|---|
| 1 | nL_G2 > 1 | Satisfaction |
| 2 | 0.7 < CA41/CA11 < 1.2 | 0.896 |
| 3 | 1 < CT1/CT3 < 2 | 1.488 |
| 4 | 0 < CT1/CT4 < 1 | 0.508 |
| 5 | 1 < ET3/CT3 < 2 | 1.431 |
| 6 | FG1 < 0 | −16.163 |
| 7 | CRA < 20 | Satisfaction |
| 8 | (TTL/DG1) > 3.5 | 5.503 |
| 9 | 2 < TTL/EPD3 < 7 | 4.181 |
| 10 | 2 < CT_Max/CT_Min < 6 | 4.104 |
| 11 | 1 < CA_Max/CA_Min < 3 | 1.308 |
| 12 | 0.1 < ΣCG_Wide/TTL < 0.6 | 0.406 |
| 13 | 0.5 < DG1/DG2 < 2 | 0.943 |
| 14 | 0.5 < DG2/DG3 < 2 | 1.100 |
| 15 | 0 < CG2/TTL < 0.2 | 0.020 |
| 16 | 2 < TTL/(DG2 + DG3) < 5 | 2.717 |
| 17 | 20 < \|Vd4 − Vd5\| < 70 | 57.658 |
| 18 | 15 < \|Vd8 − Vd7\| < 60 | 36.484 |
| 19 | 1.6 < Nd1 | 1.888 |
| 20 | 1 < L1R1/L3R2 < 3.5 | 2.356 |
| 21 | 1.5 < L1R1/L4R1 < 3.5 | 2.312 |
| 22 | 0 < L3R2/L4R1 < 2 | 0.981 |
| 23 | 1 < L1R1/L8R2 < 3 | 2.449 |
| 24 | 0 < Md12_mG2/TTL < 0.5 | 0.120 |
| 25 | 0 < Md23_mG2/TTL < 0.5 | 0.038 |
| 26 | 0.3 < Mde12_mG2/DG2 < 1 | 0.620 |
| 27 | 0 < Md23_mG3/DG3 < 0.5 | 0.217 |
| 28 | 1 < (CT1/ET1)/(CT3/ET3) < 5 | 1.381 |
| 29 | 0 < (CT1/ET1)/(CT7/ET7) < 1 | 0.493 |
| 30 | 1 < Md1 (DG12/DG23) < 5 | 2.007 |

TABLE 5

| | |
|---|---|
| Equations | Embodiment |

| | | |
|---|---|---|
| 31 | 0 < Md3(DG12/DG23) < 0.7 | 0.325 |
| 32 | 0.5 < TD2/TTL < 1 | 0.708 |
| 33 | 1 < TD1/TD2 < 1.5 | 1.223 |
| 34 | 10 < TD3 < TD2 < TD1 < 20 | Satisfaction |
| 35 | 0.1 < BFL2/TTL < 1 | 0.292 |
| 36 | 2 < BFL3/BFL1 < 4 | 2.741 |
| 37 | 1 < TD3/BFL3 < 3 | 1.716 |
| 38 | 2 < Md_CG_Max/Md_CG_Min < 8 | 5.786 |
| 39 | 1 < BFL1 < 6 | 2.929 |
| 40 | 30 < Aver_Vd < 50 | 37.296 |
| 41 | 1.5 < Aver_Nd < 1.8 | 1.642 |
| 42 | 2 < \| FG1/FG2 \| < 4 | 2.737 |
| 43 | 1 < FMd2/FMd1 < 10 | 1.528 |
| 44 | 2 < FMd2/EPD2 < 7 | 3.246 |
| 45 | 0.1 < FMd1/EPD1 < 3 | 2.453 |
| 46 | FMd1 < FMd2 < FMd3 | Satisfaction |
| 47 | 0 < TTL/FMd2 < 2 | 1.441 |
| 48 | 0.1 < TTL/FMd1 < 5 | 2.202 |
| 49 | 1 < CA_Max/ImgH < 3 | 2.143 |
| 50 | 5 < TTL/ImgH < 12 | 8.652 |
| 51 | 1 < BFL2/ImgH < 3 | 2.527 |
| 52 | 2 < BFL3/ImgH < 4 | 3.186 |
| 53 | 1 < EPD1 < EPD2 < EPD3 < 7 | Satisfaction |
| 54 | 0 < Max_Distortion < 3 | 1.200 |
| 55 | 8 < FOV3 < FOV2 < FOV1 < 45 | Satisfaction |

The optical system and camera module according to the embodiment may satisfy at least one or two or more of Equations 1 to 30 and/or Equations 31 to 55, or may satisfy all Equations.

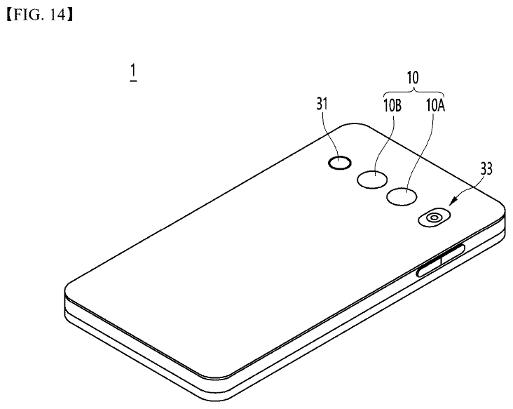

FIG. 14 is a drawing illustrating a camera module according to an embodiment applied to a mobile terminal. Referring to FIG. 14, the mobile terminal 1 may include a camera module 10 disclosed in the embodiment on the rear side. As another example, the mobile terminal 1 may include a camera module disclosed in the embodiment on the front side. The camera module 10 may include an image capturing function. In addition, the camera module 10 may include at least one of an auto focus, a zoom function, and an OIS function.

The camera module 10 may process a still image or a video image frame obtained by the image sensor 300 in a shooting mode or a video call mode. The processed image frame may be displayed on a display unit (not shown) of the mobile terminal 1 and may be stored in a memory (not shown). In addition, although not shown in the drawing, the camera module may be further arranged on the front side of the mobile terminal 1. For example, the camera module 10 may include a first camera module 10A and a second camera module 10B. At this time, at least one of the first camera module 10A and the second camera module 10B may include the optical system 1000 described above. Accordingly, the camera module 10 may have a slim structure and may capture a subject at various magnifications.

The mobile terminal 1 may further include an autofocus device 31. The autofocus device 31 may include an autofocus function using a laser. The autofocus device 31 may be mainly used in conditions where the autofocus function using the image of the camera module 10 is degraded, for example, in a close range of 10 m or less or in a dark environment. The autofocus device 31 may include a light-emitting unit including a vertical cavity surface-emitting laser VCSEL semiconductor device, and a light-receiving unit that converts light energy into electrical energy, such as a photodiode. The above mobile terminal 1 may further include a flash module 33. The flash module 33 may include a light-emitting element that emits light therein. The flash module 33 may emit light in a visible light wavelength band. For example, the flash module 33 may emit white light or light of a color similar to white. However, the embodiment is not limited thereto, and the flash module 33 may emit light of various colors. The flash module 33 may be operated by the operation of the camera of the mobile terminal or by the control of the user.

The features, structures, effects, etc. described in the embodiments above are included in at least one embodiment of the present invention, and are not necessarily limited to one embodiment. Furthermore, the features, structures, effects, etc. illustrated in each embodiment can be combined or modified and implemented in other embodiments by a person having ordinary knowledge in the field to which the embodiments belong. Therefore, the contents related to such combinations and modifications should be interpreted as being included in the scope of the present invention. Although the embodiments have been described above, they are merely examples and do not limit the present invention, and a person having ordinary knowledge in the field to which the present invention belongs will understand that various modifications and applications not illustrated above are possible without departing from the essential characteristics of the embodiments. For example, each component specifically shown in the embodiments can be modified and implemented. And the differences related to such modifications and applications should be interpreted as being included in the scope of the present invention defined in the appended claims.

1-20. (canceled)

21. An optical system comprising:
a first to third lens groups, each including at least one lens and arranged along an optical axis from an object side toward a sensor side,
wherein the first and third lens groups have negative power,
wherein the second lens group has positive power,
wherein a position of the first lens group is fixed,
wherein each of the second and third lens groups is movable along the optical axis in accordance with an operation mode,
wherein a first lens in the first lens group, which is closest to the object, has negative power and a convex surface on a sensor side,
wherein a number of lenses in the third lens group is greater than a number of lenses in the second lens group,
wherein a last lens of the lenses in the third lens group closest to an image sensor has a convex object-side surface and a concave sensor-side surface on the optical axis,
wherein a distance along the optical axis of the first lens group is defined as DG1,
wherein a distance along the optical axis of the second lens group is defined as DG2, and
wherein the following Equation satisfies:
$$0.5 < DG 1 / DG 2 < 2.$$

22. The optical system of claim 21, wherein the first lens is made of glass, and other lenses in the first lens group are made of plastic.

23. The optical system of claim 21, wherein a lens in the second lens group closest to the first lens group is made of glass, and remaining lenses in the second lens group are made of plastic.

24. The optical system of claim 21, wherein object-side and sensor-side surfaces of lenses in the first to third lens groups are aspherical on the optical axis.

25. The optical system of claim 21, wherein a distance along the optical axis of the third lens group is defined as DG3, a distance along the optical axis from an object-side surface of the lens in the first lens group closest to the object to a top surface of the image sensor is defined as TTL, and wherein the following Equation satisfies:
$$2 < TTL / ( DG 2 + DG 3 ) < 5.$$

26. The optical system of claim 21, wherein a distance along the optical axis between the last lens closest to the image sensor in the third lens group and the image sensor is variable in accordance with the operation mode, and the operation mode includes a wide mode, a middle mode, and a tele mode.

27. The optical system of claim 26, wherein a distance along the optical axis between an object-side surface of the lens closest to the object in the first lens group and the sensor-side surface of the last lens closest to the image sensor in the third lens group is variable in accordance with the operation mode, and a distance between the first and second lens groups and a distance between the second and third lens groups are equal to or greater than 0.2 mm and equal to or less than 8 mm.

28. The optical system of claim 26, wherein the wide mode is defined as Md1, a distance between the first and second lens groups in the wide mode is defined as DG12, a distance between the second and third lens groups is defined as DG23, and wherein the following Equation satisfies:
$$1 < Md 1 \times ( DG 12 / DG 23 ) < 5.$$

29. The optical system of claim 26, wherein the tele mode is defined as Md3, a distance between the first and second lens groups in the tele mode is defined as DG12, a distance between the second and third lens groups is defined as DG23, and
wherein the following Equation satisfies:
$$0 < Md 3 \times ( DG 12 / DG 23 ) < 0.7 .$$

30. The optical system of claim 21, wherein a maximum distance between adjacent lenses in accordance with the operation mode is defined as Md_CG_Max, a minimum distance between adjacent lenses in accordance with the operation mode is defined as Md_CG_Min, and
wherein the following Equation satisfies:
$$2 < Md \_CG \_Max / Md\_CG \_Min < 8.$$

31. The optical system of claim 21, wherein the number of lenses in the first lens group is greater than the number of lenses in the second lens group, and an absolute value of the focal length of the first lens group is greater than that of the second lens group.

32. The optical system of claim 26, wherein an effective focal length in the wide mode is defined as FMd1, a focal length of the first lens is defined as F1, and
wherein the following Equation satisfies:
$$2 < \vert F 1 / FMd 1 \vert < 7.$$

33. The optical system of claim 26, wherein an effective focal length in the tele mode is defined as FMd3, and
wherein the following Equation satisfies:
$$0 < \vert F 1 / FMd 3 \vert < 1$$
is satisfied.

34. The optical system of claim 26, wherein a field of view in the wide mode is defined as FOV1, a field of view in the middle mode is defined as FOV2, a field of view in the tele mode is defined as FOV3, and
wherein the following Equation satisfies:
$$8 ° < FOV 3 < FOV 2 < FOV 1 < 45 ° .$$

35. An optical system comprising:
a first lens group including first to third lenses;
a second lens group including fourth and fifth lenses; and
a third lens group including sixth to eighth lenses,
wherein the first to third lens groups are arranged in order from an object side toward a sensor side along an optical axis,
wherein the first lens has negative refractive power, and has a convex object-side surface,
wherein the third lens has negative refractive power, and has a concave sensor-side surface,
wherein the fourth lens has positive refractive power and a biconvex shape,
wherein the eighth lens has negative refractive power,
wherein the second and third lens groups are movable along the optical axis,
wherein a distance between the eighth lens and the image sensor is variable in accordance with an operation mode,
wherein a refractive index of the first lens is defined as Nd1, and
wherein the following Equation satisfies:
$$1.7 < Nd 1.$$

36. The optical system of claim 35, wherein the first and third lens groups have negative refractive power, and the second lens has positive refractive power.

37. The optical system of claim 35, wherein the fourth lens and the eighth lens each have a refractive index less than 1.6, and the first and fourth lenses are aspherical lenses made of glass.

38. The optical system of claim 35, wherein a maximum length of a first direction perpendicular to the optical axis and a maximum length of a second direction of the first lens are different from each other.

39. The optical system of claim 35, wherein a maximum effective size of the largest lens surface among the first to eighth lenses is defined as CA_Max, and half of a diagonal length of the image sensor is defined as ImgH, and
wherein the following Equation satisfies:
$$1 < CA\_Max / ImgH < 3.$$

40. A camera module comprising:
an image sensor;
an optical system; and
a driving member configured to move at least one of a plurality of lens groups in the optical system along an optical axis,
wherein the optical system includes the optical system of claim 21, and the driving member is configured to move positions of each of the second and third lens groups in the optical axis.
